(19) United States
(12) Patent Application Publication
(10) Pub. No.: US 2024/0151397 A1
(43) Pub. Date: May 9, 2024

(54) INJECTION TECHNIQUES FOR GAS TURBINE SYSTEMS

(71) Applicant: GTS Research & Engineering, LLC, Jefferson, MD (US)

(72) Inventor: Anthony Richard Martinez, Clarksburg, MD (US)

(21) Appl. No.: 18/417,585

(22) Filed: Jan. 19, 2024

Related U.S. Application Data
(63) Continuation of application No. PCT/US22/39011, filed on Aug. 1, 2022.
(60) Provisional application No. 63/228,865, filed on Aug. 3, 2021.

(51) Int. Cl. F23R 3/34; F02C 3/30

(52) U.S. Cl. CPC F23R 3/346; F02C 3/30; F05D 2240/36

(57) ABSTRACT

The present teachings generally include improvements to gas turbines for increasing performance and/or efficiency thereof. In an aspect, a gas turbine system featuring a free turbine includes an injector structurally configured to supply liquid water between a last stage turbine rotor of the gas turbine and a last stage turbine rotor of the free turbine. In this manner, heat transferred from combustion gases to the liquid water may cause vaporization of the water. In turn, one or more of (i) a pressure increase from the vaporization of the water and (ii) an increase in mass flow rate across a free turbine rotor from the addition of the water into the system may increase power output of the free turbine. Thus, in some aspects, power output can be increased without the need for an increase in fuel consumption.

### CROSS-REFERENCE TO RELATED APPLICATIONS

This application is a bypass continuation that claims priority to International Patent Application No. PCT/US22/39011 filed on Aug. 1, 2022, which claims priority to U.S. Provisional Patent App. No. 63/228,865 filed on Aug. 3, 2021, where the entire content of each of the foregoing is hereby incorporated by reference herein.

### FIELD

The present disclosure generally relates to devices, systems, and methods for improving the performance of gas turbines and/or combined-cycle power plants, e.g., by including water injection between the last stage turbine rotor of a gas turbine and the last stage turbine rotor of a free turbine within a gas turbine system.

### BACKGROUND

There are many inefficiencies in current power plants, such as conventional natural gas combined-cycle and simple-cycle plants. For example, compressors on natural gas heavy-duty industrial gas turbines typically require in excess of 66% percent of the mechanical power generated from the turbines—thus greatly reducing output power of the turbines. Consequently, this inefficiency reduces the potential for generating far more electricity. There remains a need for improved gas turbines and gas turbine systems.

### SUMMARY

The present teachings generally include improvements to gas turbines for increasing performance and/or efficiency thereof. In an aspect, a gas turbine system featuring a free turbine includes an injector structurally configured to supply liquid water between a last stage turbine rotor of the gas turbine and a last stage turbine rotor of the free turbine. In this manner, heat transferred from combustion gases to the liquid water may cause vaporization of the water. In turn, one or more of (i) a pressure increase from the vaporization of the water and (ii) an increase in mass flow rate across a free turbine rotor from the addition of the water into the system may increase power output of the free turbine. Thus, in some aspects, power output can be increased without the need for an increase in fuel consumption.

In an aspect, a gas turbine system disclosed herein may include: a first turbine having one or more first turbine rotors including a last stage first turbine rotor; a second turbine, where the second turbine is a free turbine disposed downstream from the first turbine relative to a fluid path of combustion gases through the gas turbine system, the free turbine having one or more free turbine rotors including a last stage free turbine rotor disposed furthest downstream along the fluid path from the first turbine; and an injector disposed downstream along the fluid path from the last stage first turbine rotor, the injector structurally configured to supply liquid water between the last stage first turbine rotor and the last stage free turbine rotor, where, when so supplied by the injector, heat transferred from the combustion gases to the liquid water causes vaporization of the water, and where a pressure increase from the vaporization increases power output of the second turbine.

Implementations may include one or more of the following features. The supply of liquid water by the injector may increase a mass flow rate across at least one of the free turbine rotors to increase power output thereof. The injector may be structurally configured to supply liquid water within an inlet zone of the free turbine, the inlet zone disposed between the last stage first turbine rotor and a first stage free turbine rotor of the free turbine rotors. The injector may be structurally configured to supply liquid water between a first stage free turbine rotor and the last stage free turbine rotor. The injector may be a nozzle of the free turbine, the nozzle structurally configured to spray liquid water approximate to at least one of the free turbine rotors. The injector may be structurally configured to supply liquid water between a shroud of the free turbine and at least one of the free turbine rotors. The injector may be structurally configured to supply liquid water approximate to a radial strut of a housing of the gas turbine system. The injector may be disposed within the radial strut. The liquid water may be supplied by the injector at a pressure between 2.75 Bar and 220 Bar, inclusive. The liquid water may be supplied by the injector at a temperature between 200-degrees Fahrenheit (93.33-degrees Celsius) and 705-degrees Fahrenheit (373.89-degrees Celsius), inclusive. The liquid water may be filtered and/or purified before being supplied by the injector. The last stage first turbine rotor may be the only turbine rotor of the first turbine. The first turbine may be a multistage turbine such that the last stage first turbine rotor is one of a plurality of turbine rotors of the first turbine. The last stage free turbine rotor may be the only turbine rotor of the free turbine. The free turbine may be a multistage turbine such that the last stage free turbine rotor is one of a plurality of turbine rotors of the free turbine. A shaft of the free turbine may be uncoupled from a shaft of the first turbine. The system may further include a compressor disposed upstream from the first turbine and coupled to the first turbine. The compressor and the first turbine may be disposed along a common shaft. A shaft of the free turbine may be distinct from the common shaft. The system may further include a gear reduction unit disposed downstream from the free turbine. The system may further include an electric generator coupled to the free turbine. No excess fuel may be provided to the first turbine for the increased power output of the second turbine. The system may lack a heat recovery steam generator (HRSG). The supply of liquid water by the injector may reduce exhaust gas temperature for the gas turbine system. The supply of liquid water by the injector may reduce one or more of carbon emissions and nitrogen emissions for the gas turbine system. Water used for the supply of water may be preheated prior to being supplied by the injector. Water used for the supply of water may be preheated by exhaust gases from the first turbine.

In an aspect, an apparatus for supplementing a gas turbine disclosed herein may include: a housing structurally configured for coupling to an existing gas turbine, the existing gas turbine including a first turbine having one or more first turbine rotors including a last stage first turbine rotor; a second turbine at least partially disposed within the housing, where the second turbine is a free turbine having one or more free turbine rotors including a last stage free turbine rotor disposed furthest downstream from the first turbine relative to a fluid path of combustion gases through the existing gas turbine when the housing is coupled to the existing gas turbine; and an injector coupled to the housing such that, when the housing is coupled to the existing gas turbine, the injector is disposed downstream from the last stage first turbine rotor, the injector structurally configured to supply liquid water between the last stage first turbine rotor and the last stage free turbine rotor, where, when so supplied by the injector, heat transferred from the combustion gases from the existing gas turbine to the liquid water causes vaporization of the water, and where a pressure increase from the vaporization increases power output of the second turbine.

Implementations may include one or more of the following features. The supply of liquid water by the injector may increase a mass flow rate across at least one of the free turbine rotors to increase power output thereof. The injector may be structurally configured to supply liquid water within an inlet zone of the free turbine, the inlet zone disposed between the last stage first turbine rotor and a first stage free turbine rotor of the free turbine rotors. The injector may be structurally configured to supply liquid water between a first stage free turbine rotor and the last stage free turbine rotor. The injector may be a nozzle of the free turbine, the nozzle structurally configured to spray liquid water approximate to at least one of the free turbine rotors. The injector may be structurally configured to supply liquid water between a shroud of the free turbine and at least one of the free turbine rotors. The injector may be structurally configured to supply liquid water approximate to a radial strut of the housing. The injector may be disposed within the radial strut. The liquid water may be supplied by the injector at a pressure between 2.75 Bar and 220 Bar, inclusive. The liquid water may be supplied by the injector at a temperature between 200-degrees Fahrenheit (93.33-degrees Celsius) and 705-degrees Fahrenheit (373.89-degrees Celsius), inclusive. The liquid water may be filtered and/or purified before being supplied by the injector. The last stage first turbine rotor may be the only turbine rotor of the first turbine. The first turbine may be a multistage turbine such that the last stage first turbine rotor is one of a plurality of turbine rotors of the first turbine. The last stage free turbine rotor may be the only turbine rotor of the free turbine. The free turbine may be a multistage turbine such that the last stage free turbine rotor is one of a plurality of turbine rotors of the free turbine. A shaft of the free turbine may remain uncoupled from a shaft of the first turbine. The apparatus may further include a compressor disposed upstream from the first turbine and coupled to the first turbine. The compressor and the first turbine may be disposed along a common shaft. A shaft of the free turbine may be distinct from the common shaft. The apparatus may further include a gear reduction unit disposed downstream from the free turbine. The apparatus may further include an electric generator coupled to the free turbine. No excess fuel may be provided to the first turbine for the increased power output of the second turbine. The apparatus may lack a heat recovery steam generator (HRSG). The supply of liquid water by the injector may reduce exhaust gas temperature. The supply of liquid water by the injector may reduce one or more of carbon emissions and nitrogen emissions.

In an aspect, a method disclosed herein may include: providing an injector downstream from a first turbine relative to a fluid path of combustion gases through the first turbine; supplying liquid water at a location between the first turbine and a last stage free turbine rotor of a free turbine that is disposed downstream from the first turbine relative to the fluid path; transferring heat from the combustion gases to the liquid water to vaporize the liquid water; and increasing a power output of the free turbine, where the increase in power output of the free turbine is caused at least in part by a pressure increase from vaporization of the liquid water.

Implementations may include one or more of the following features. Providing the injector may include retrofitting an existing gas turbine system with a nozzle in communication with a supply of water. Retrofitting the existing gas turbine system may include converting one or more existing nozzles in the gas turbine system to supply water within the gas turbine system. Retrofitting the existing gas turbine system may include coupling one or more new nozzles to the gas turbine system to supply water within the gas turbine system. Retrofitting the existing gas turbine system may further include placing the free turbine adjacent to an outlet of the first turbine. One or more new nozzles may be disposed on the free turbine. The method may further include maintaining a fuel supply that can be used for the first turbine absent the supply of liquid water. The method may further include generating electricity from the power output of the free turbine. The increase in power output of the free turbine may be caused at least in part by an increase in mass flow rate from the supply of liquid water. The location may include an inlet zone of the free turbine, the inlet zone disposed between a last stage first turbine rotor of the first turbine and a first stage free turbine rotor of the free turbine. The location may be disposed between a first stage free turbine rotor and the last stage free turbine rotor. The injector may include a nozzle of the free turbine, the nozzle structurally configured to spray liquid water approximate to at least one free turbine rotor. The injector may be structurally configured to supply liquid water between a shroud of the free turbine and at least one free turbine rotor. The injector may be structurally configured to supply liquid water approximate to a radial strut of a housing of one or more of the first turbine and the free turbine. The injector may be disposed within the radial strut. The liquid water may be supplied at a pressure between 2.75 Bar and 220 Bar, inclusive. The liquid water may be supplied at a temperature between 200-degrees Fahrenheit (93.33-degrees Celsius) and 705-degrees Fahrenheit (373.89-degrees Celsius), inclusive. The liquid water may be filtered and/or purified before being supplied. The first turbine may be a multistage turbine. The last stage free turbine rotor may be the only turbine rotor of the free turbine. The free turbine may be a multistage turbine such that the last stage free turbine rotor is one of a plurality of turbine rotors of the free turbine. A shaft of the free turbine may be uncoupled from a shaft of the first turbine. The method may further include providing a compressor disposed upstream from the first turbine and coupled to the first turbine. The compressor and the first turbine may be disposed along a common shaft. A shaft of the free turbine may be distinct from the common shaft. The method may further include providing a gear reduction unit disposed downstream from the free turbine. The method may further include providing an electric generator coupled to the free turbine. No excess fuel may be provided to the first turbine for the increased power output of the free turbine. The method may further include reducing exhaust gas temperature of one or more of the first turbine and the free turbine. The method may further include reducing one or more of carbon emissions and nitrogen emissions of one or more of the first turbine and the free turbine. The method may further include preheating the liquid water. The liquid water may be preheated using exhaust gases from a turbine.

These and other features, aspects, and advantages of the present teachings will become better understood with reference to the following description, examples, and appended claims.

### BRIEF DESCRIPTION OF THE DRAWINGS

The foregoing and other objects, features, and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1 is an operational diagram of a gas turbine system, in accordance with a representative embodiment.

FIG. 2 is a process diagram of a gas turbine system, in accordance with a representative embodiment.

FIG. 3 shows a gas turbine and an apparatus for supplementing a gas turbine, in accordance with a representative embodiment.

FIG. 4 is a flow chart of a method demonstrating injection techniques for gas turbines, in accordance with a representative embodiment.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “about,” “approximately,” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

In general, the devices, systems, and methods disclosed herein relate to improvements to gas turbines and gas turbine systems, e.g., for increasing performance and/or efficiency thereof. The present teachings may be utilized in a gas turbine or a gas turbine system that includes a free turbine. As used herein, such a “free turbine” will be understood to be a turbine that is uncoupled from a compressor of the overall gas turbine system, and more particularly, uncoupled from one or more high- and/or intermediate-pressure turbines that may themselves be coupled to the compressor. More specifically, the shaft that is coupled to the free turbine (e.g., the power shaft that is connected to an electric generator or the like) may be uncoupled from the compressor and/or one or more high-pressure turbines connected thereto. In this manner, in an aspect, high-pressure turbines and/or intermediate-pressure turbines are independent from the free turbine; stated differently, a power shaft of the free turbine is uncoupled from one or more high- and/or intermediate-pressure turbines of a gas turbine system. Thus, the power shaft of such a free turbine may be independent of other powertrains, and the free turbine(s) may sit independently on its own shaft.

The present teachings may more specifically include a water injection system for augmenting free-turbine power output of a gas turbine engine. This may include liquid water supplied between a last stage turbine rotor of a first turbine in a turbine system (e.g., a high- or intermediate-pressure turbine) and a last stage turbine rotor of a free turbine disposed downstream from the first turbine in the turbine system. More specifically, in an aspect, a gas turbine featuring a free turbine includes a system for injecting water at an inlet of the free turbine, which may also be referred to herein and in the art as the “N3 free-turbine inlet zone” or similar. The water injection system may be structurally configured to inject water (e.g., pressurized water, which may be in liquid or steam form) into direct contact with high-temperature gases situated within the inlet zone of the free turbine, i.e., such that the location of water injection is disposed downstream of a high-pressure turbine and/or an intermediate-pressure turbine, and more particularly between a discharge thereof and the inlet of the free turbine. When water is injected in this location, heat from the high-temperature gases may be transferred to the water, and, as a result, the resulting pressure from steam vaporization may be applied as augmented pressure across the free turbine(s) increasing power output therefrom. In this manner, power output can be increased without the need for a drastic increase in fuel consumption.

Because various components within a gas turbine system may be described in a multitude of ways, and can include many synonymous terms, several terms will now be defined for understanding the description herein related to the present teachings.

A “turbine” as used herein will be understood to generally include a rotary mechanical device that extracts energy from a fluid flow and converts it into useful work. The work produced by such a turbine can be used for generating electrical power when combined with a generator. A turbine generally includes a rotor assembly, which includes a shaft with one or more rotors engaged thereto, where rotation of the shaft causes rotation of the turbine rotors.

Thus, a “turbine rotor” as used herein will be understood to include the wheel, cylinder, blade, or other similar structure that is rotated on the shaft of a turbine. The turbine rotor will typically have one or more blades thereon (which may also be referred to as buckets), where moving fluid (e.g., combustion gases) act on the turbine rotor(s) and/or blades thereof so that they move and impart rotational energy within the turbine system.

Unless expressly stated to the contrary or otherwise clear from the context, “upstream” and “downstream” as used herein will be understood to refer to a relative location within a turbine system related to the direction of flow of fluid (e.g., combustion gases) therethrough. For example, if component ‘x’ in a turbine system is described as being disposed upstream from component ‘y’ in the turbine system, it will be understood that component ‘x’ may be located closer to the intake of the system than component ‘y’ and further from the exhaust than component ‘y’ in the turbine system.

A “multistage turbine” as used herein will be understood to include a turbine having more than one turbine rotor. In such a multistage turbine, the first turbine rotor would be referred to as the “first stage turbine rotor,” and the last turbine rotor would be referred to as the “last stage turbine rotor,” where it will be understood that the last stage turbine rotor is disposed downstream from the first stage turbine rotor in such a multistage turbine (and, similarly, the first stage turbine rotor is disposed upstream from the last stage turbine rotor in such a multistage turbine). Turbine rotors between the first and last stage turbine rotors may be referred to as “intermediate” turbine rotors.

A “free turbine” as described above may include a turbine that is uncoupled from a compressor in a gas turbine system, and in most cases, a free turbine will be similarly uncoupled from another turbine in a gas turbine system, where this other turbine can be coupled to the compressor. In this manner, the shaft that is coupled to the free turbine (which may be a power shaft that is connected to an electric generator or the like) may be uncoupled from the compressor and/or one or more other turbines. Thus, one or more turbines disposed upstream within a turbine system from the free turbine may be independent from the free turbine such that a shaft of the free turbine is uncoupled from a shaft of an upstream turbine and/or a compressor. Thus, the power shaft of a free turbine may be independent of other powertrains, and the free turbine may sit independently on its own shaft. It will be understood, however, that in some gas turbine systems, shafts of one or more of a compressor and a turbine disposed upstream from a free turbine may still traverse through the free turbine, but generally, these shafts would be structurally configured such that the free turbine can rotate freely relative to these shafts—e.g., through the use of gaps and/or bearings and the like (such as where these shafts are coaxial relative to one another), and/or where each shaft has its own associated generator or the like. Thus, when a free turbine in this disclosure is described as being uncoupled from another component, independent of another component, and/or disposed on a distinct shaft from another component, it will be understood that this generally refers to embodiments where the shaft(s) of these other components would not affect (or be affected by) rotation of a free turbine (and its shaft) unless expressly stated to the contrary or otherwise clear from the context.

It will be understood that, although the present teachings may emphasize a liquid water injection system for augmenting free-turbine power output of a gas turbine engine/system, substances other than water (and certain water mixtures with one or more other substances) may also or instead be included in aspects of the present teachings. That is, in certain aspects, liquid water (e.g., substantially pure liquid water) may be used in the present teachings because it yields advantageous output (e.g., because of the exponential water-to-steam expansion ratio of about 1600:1) and has distinct cost advantages over other options. However, other substances may also or instead be used. By way of example, a mixture could be applied (although this will likely increase costs) such as a water-methanol mixture and the like. Other substances and mixtures are also or instead possible as will be understood by a skilled artisan. Thus, certain aspects of the present teachings may include a fluid injection system (e.g., a liquid injection system) for augmenting free-turbine power output of a gas turbine engine or system, where such a fluid may include liquid water, steam, supercritical water, a water mixture with another substance, another substance that is free or substantially free of water, and so on. Furthermore, it will be understood that in some implementations, the water and/or water source used may go through a water treatment process, e.g., according to industrial turbine steam purity specifications or guidelines for water quality and/or water chemistry limits Such steam purity methods may prevent high chemical contamination and excessive alkalinity. Examples of turbine steam purity specifications and limits may include for example that sodium in steam is less than 5 parts per billion or that steam has certain limits on levels of silica, sodium, cation conductivity, excessive phosphate carryover, and so on. In general, water used herein may be treated for the prevention or mitigation of corrosive substances such as weak acids and the like that can corrode or otherwise damage the turbine blades or other components in a system featuring the present teachings. Also or instead, components in apparatuses or systems featuring the present teachings may be reinforced to protect against such damage and/or corrosion, such as through the inclusion of a coating (e.g., a ceramic coating or the like) on components such as turbine blades and the like.

It will further be understood that “modified” gas turbines and the like as used herein shall include a gas turbine that utilizes one or more components of the present teachings, such as a liquid water injector disposed at the N3 free-turbine inlet zone as defined herein, or more generally, a liquid water injector disposed between a last stage turbine rotor of a first turbine in a turbine system (e.g., the high- or intermediate-pressure turbine, which may otherwise be referred to as a combustion turbine) and the last stage turbine rotor of a free turbine disposed downstream from the first turbine in the turbine system. It will be further understood that such “modified” gas turbines and the like may include existing gas turbines that are retrofitted with one or more components of the present teachings and/or newly constructed gas turbines with one or more components of the present teachings integrated thereon or therein.

Thus, the present teachings may include techniques that can increase the performance of gas turbines, where the present teachings may be implemented into existing conventional natural gas simple and combined-cycle plants. The present teachings may involve the delivery of liquid water within a specific region of the turbine system. This specific region may include any region downstream of a first turbine (e.g., a turbine within the turbine system that is coupled to, and shares a common shaft with, a compressor) and upstream from the last rotor of a free turbine in the turbine system. By way of example, a turbine system may include a compressor coupled to a first turbine, where the first turbine is a multistage turbine, which for the sake of example, can include four turbine rotors (a first turbine rotor, a second turbine rotor, a third turbine rotor, and a fourth turbine rotor, where the first turbine rotor is the first stage turbine rotor and the fourth turbine rotor is the last stage turbine rotor). This example turbine system may include a second turbine in the form of a free turbine disposed downstream from the first turbine, and the free turbine may similarly be a multistage turbine, which for the sake of example also includes four free turbine rotors (a first free turbine rotor, a second free turbine rotor, a third free turbine rotor, and a fourth free turbine rotor, where the first free turbine rotor is the first stage free turbine rotor and the fourth free turbine rotor is the last stage free turbine rotor). Thus, using this example, the specific region where liquid water is injected may include anywhere between the last stage turbine rotor of the first turbine and the last stage free turbine rotor of the free turbine (i.e., anywhere between the fourth turbine rotor of the first turbine and the fourth free turbine rotor of the free turbine). Within this region, one specific sub-region that may be advantageous for the injection of liquid water may include the N3-inlet zone, which will be understood to generally include a region downstream from the last stage turbine rotor and the first stage free turbine rotor, or more generally, between a free turbine and a turbine disposed upstream from the free turbine in a gas turbine system (e.g., into the entrance of the inlet zone of the free turbine in a turbine system).

Thus, the present teachings may include devices, systems, and techniques for introducing liquid water in a strategic, beneficial location within a gas turbine system that includes a gas turbine and a free turbine—i.e., a location essentially anywhere downstream of the gas turbine, but upstream of the last stage free turbine rotor (or only turbine rotor) of the free turbine. In some aspects, the location includes the N3-inlet zone, which is described in more detail below. The location where liquid water is injected as per the present teachings may include a particularly sensitive area of expansion—meaning, in such an area, the expansion process may gain considerable pressure energy that augments power to one or more free turbine rotors, which can increase power/efficiency of the free turbine and lead to noteworthy overall gas turbine performance. That is, injecting liquid water in locations according to present teachings may be advantageous because, in these locations, expansion from the heating of the injected water may be used to create relatively high-pressure steam, which in turn may be used to provide power to the free turbine. Whereas, if the water injection is disposed in another location, such advantageous pressurized steam may not be utilized effectively or efficiently. A phenomenon that occurs when liquid water is rapidly converted into steam is that it exhibits an exponential water-to-steam expansion ratio of about 1600:1. Thus, this means that an injection system according to the present teachings that delivers high-quality liquid water, and thus high-quality steam once combined with combustion gases, within a location aft of the gas turbine (e.g., a first turbine coupled to a compressor) but before the last stage of a free turbine may increase the mechanical drive power output of one or more free turbine rotors and may increase the average torque of the free turbine rotors, thus increasing available turbine work. This can add to the overall power output of the whole gas turbine system, considerably increasing fuel efficiency. In this manner, the present teachings may be related to improving the overall efficiency of a natural gas power plant and reducing its emissions considerably.

The present teachings may thus be related to the compressors and turbines of industrial gas turbines, which may represent some of the most critical components of natural gas power plants. In this manner, the present teachings may provide advantages to these turbines related to compressor efficiency and compressor work. That is, most gas turbines suffer from incredible energy loss stemming from the required compressor work (which may be about 66%). The compressors of industrial gas turbines may consume the majority portion of energy given by the turbine work, which greatly degrades turbine work. However, the present teachings can restore and boost turbine work on a continuous operating cycle—e.g., by delivering liquid water injected into a modified gas turbine. The subsequent steam dynamics may function with respect to the enthalpy of saturated steam. A liquid water injection method according to the present teachings may deliver high quality filtered water (e.g., according to industrial turbine steam purity specifications/guidelines for water quality/water chemistry limits) after the turbine discharge stage also known as N2f (high pressure or “hp” turbine outlet) by means of delivering relatively high-pressure atomized water injection at a relatively low micron diameter size. The resultant effect of the steam heat of vaporization process may be that the steam vaporization pressure will be applied as augmented pressure across one or more free turbine zones. Meaning there may be an increase in pressure and mass flow rate, and a resulting increase in mechanical drive power output of the free turbines (also known as increased turbine work). Introducing high-pressure water-to-steam may be advantageous because of the particularly sensitive area of expansion that can occur downstream from the hp turbine outlet. Specifically, the expansion process may gain considerable pressure energy that augments power to the free turbine rotor(s), which is noteworthy because the effects to compressor demands may be negligible because there may be no axial connection between compressor/hp turbine rotors and the free turbine rotors. Thus, the increased mass flow rate may not increase power to the high-pressure turbine rotors (e.g., the first turbine) but only to the free turbine rotor(s). And, as such, extra fuel may not be required to compensate for stoichiometric combustion, which may represent a significant improvement for gas turbines featuring free turbines. Additionally, the present teachings may significantly reduce the scale of, or outright eliminate a need for, heat recovery steam generators (HRSGs). In some implementations, simple cycle gas turbine plants utilizing the present teachings will be considerably more cost effective due to more power output with less fuel required and no heat recovery steam generators, lowering the capital requirements and further reducing the levelized cost of electricity. The present teachings may thus be used to effectively lower energy costs on a national scale and/or to provide significant and practical cost benefits.

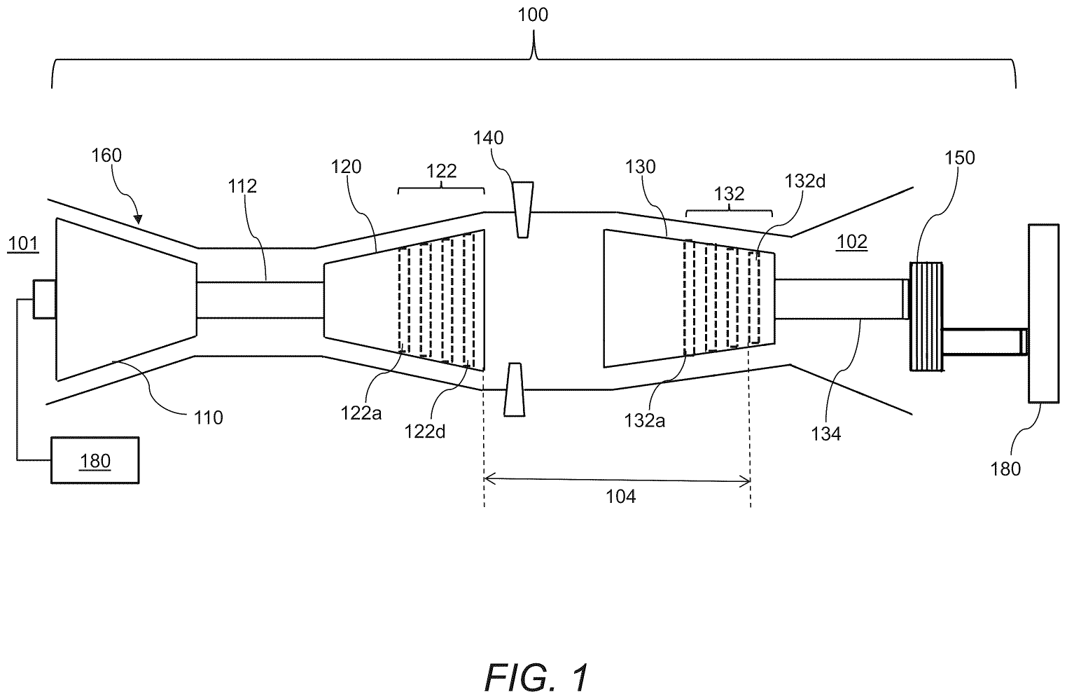

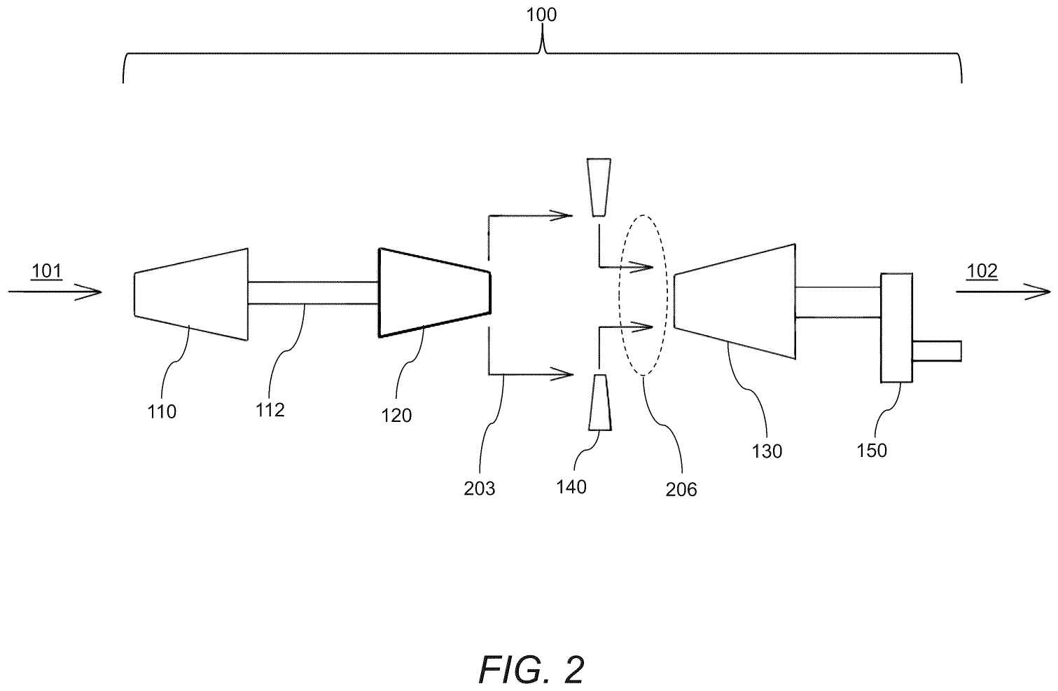

FIG. 1 is an operational diagram of a turbine system (e.g., a gas turbine system), in accordance with a representative embodiment, and FIG. 2 is a process diagram of a turbine system (e.g., a gas turbine system), in accordance with a representative embodiment. It will be generally understood that these drawings show a similar configuration, but where FIG. 2 includes arrows showing the flow of fluids through the turbine system 100. Thus, these figures shall be discussed together. In general, the turbine system 100 may include a compressor 110, a first turbine 120, a second turbine 130 (e.g., a free turbine), one or more injectors 140, a gear reduction unit 150, and one or more electric generators 180. One or more components of the turbine system 100 may be at least partially contained within a housing 160. The figures also show an intake region 101 and an exhaust region 102, where it will be understood that the intake region 101 is located upstream from the exhaust region 102, and similarly, the exhaust region 102 is located downstream from the intake region 101.

The compressor 110 may be any known in the art. In some implementations, and as shown in FIGS. 1 and 2, the compressor 110 may be coupled to the first turbine 120. That is, the compressor 110 may be disposed upstream from the first turbine 120 and coupled to the first turbine 120 in an aspect. In some implementations, the compressor 110 and the first turbine 120 are disposed along a common shaft 112. As shown in the figures, the common shaft 112 may be independent and distinct from a shaft 134 of the second turbine 130. Thus, the shaft 134 of a free turbine may be uncoupled from a shaft of the first turbine 120, such as the common shaft 112 shown in the figure. In some aspects, the common shaft 112 may traverse through at least a portion of the second turbine 130. In such configurations, however, the second turbine 130 may rotate substantially independently from the common shaft 112. Thus, in an aspect, the compressor 110 and/or the first turbine 120 may be substantially rotationally independent from the second turbine 130.

The first turbine 120 may be a gas turbine or high-pressure turbine—i.e., a turbine powered by combustion gases within the turbine system 100. The first turbine 120 may include one or more first turbine rotors 122. That is, in an aspect, the first turbine 120 may include a single stage turbine featuring only one first turbine rotor 122; in another aspect, the first turbine 120 may include a multistage turbine featuring a plurality of first turbine rotors 122. In the example shown in FIG. 1, four first turbine rotors 122 are shown, including a first stage first turbine rotor 122a and a last stage first turbine rotor 122d, where it will be understood that more or less first turbine rotors 122 are also or instead possible in implementations of the present teachings. Turning back to FIG. 1, in an embodiment where the first turbine 120 is a multistage turbine, the first stage first turbine rotor 122a is disposed upstream from the last stage first turbine rotor 122d relative to the flow of combustion gases or other fluids through the turbine system 100. However, it will be understood that, in an implementation where the first turbine 120 is a single stage turbine, the “last stage first turbine rotor” as described herein may actually be the only turbine rotor included in the first turbine 120. Stated otherwise, the last stage first turbine rotor 122d may be the only turbine rotor of the first turbine 120; or, alternatively, the first turbine 120 may be a multistage turbine such that the last stage first turbine rotor 122d is one of a plurality of turbine rotors of the first turbine 120. Thus, in general, the first turbine 120 includes one or more first turbine rotors 122 including a last stage first turbine rotor 122d.

The first turbine 120 may be the only turbine (e.g., besides a free turbine) in a turbine system 100. However, it will be understood that the first turbine 120 as described herein is generally the turbine that is directly upstream from a free turbine (i.e., the second turbine 130 in the figure) in the turbine system 100, where it will be further understood that other components, including other turbines and/or compressors, may be disposed further upstream from the first turbine 120 and/or downstream from the second turbine 130. Thus, in this manner, the first turbine 120 will be understood as not being required to be the actual “first” sequential turbine in a system having a plurality of turbines that are uncoupled from a free turbine. Alternatively, the first turbine 120 may actually be the “first” sequential turbine in a system featuring a plurality of turbines. Moreover, in embodiments where the first turbine 120 is the only turbine in a turbine system 100, the second turbine 130 may be independent from the first turbine 120, but may still utilize exhaust gasses or the like from the first turbine 120, e.g., for powering free turbine rotors or the like, and/or for heating water to be supplied to an inlet or other advantageous zone as described herein for implementing an aspect of the present teachings.

The second turbine 130 may be a free turbine as described herein, and in general, when discussion the turbine system 100 of FIGS. 1 and 2, reference to a “free turbine” will be understood to be referring to the second turbine 130, and vice-versa, unless explicitly stated to the contrary or otherwise clear from the context. That is, the second turbine 130 may be a free turbine disposed downstream from the first turbine 120 relative to a fluid path (as shown generally by the arrows 203 in FIG. 2) of combustion gases through the turbine system 100. The free turbine may include one or more free turbine rotors 132 including a last stage free turbine rotor 132d disposed furthest downstream along the fluid path from the first turbine 120 and/or a first stage free turbine rotor 132a.

Thus, the second turbine 130 may include one or more free turbine rotors 132. That is, in an aspect, the second turbine 130 may include a single stage turbine featuring only one free turbine rotor 132; in another aspect, the second turbine 130 may include a multistage turbine featuring a plurality of free turbine rotors 132. In the example shown in FIG. 1, four free turbine rotors 132 are shown, including a first stage free turbine rotor 132a and a last stage free turbine rotor 132d, where it will be understood that more or less free turbine rotors 132 are also or instead possible in implementations of the present teachings. Turning back to FIG. 1, in an embodiment where the second turbine 130 is a multistage turbine, the first stage free turbine rotor 132a is disposed upstream from the last stage free turbine rotor 132d relative to the flow of combustion gases or other fluids through the turbine system 100. However, it will be understood that, in an implementation where the second turbine 130 is a single stage turbine, the “last stage free turbine rotor” as described herein may actually be the only turbine rotor included in the second turbine 130. Stated otherwise, the last stage free turbine rotor may be the only turbine rotor of the free turbine; or, alternatively, the free turbine may be a multistage turbine such that the last stage free turbine rotor is one of a plurality of turbine rotors of the free turbine. Thus, in general, the second turbine 130 includes one or more free turbine rotors 132 including a last stage free turbine rotor 132d.

As discussed above, the turbine system 100 may include one or more injectors 140. An injector 140 may be disposed within the turbine system 100 downstream along the fluid path from the first turbine 120, and more specifically, downstream from the last stage first turbine rotor 122d of the first turbine 120 (which, again, may be the last turbine rotor of a multistage turbine or the only turbine rotor of a single stage turbine). More specifically, the injector 140 may be disposed between the last stage first turbine rotor 122d of the first turbine 120 and the last stage free turbine rotor 132d of the second turbine 130, which again may include a free turbine (and, where it will be understood that the last stage free turbine rotor 132d of the second turbine 130 may be the last turbine rotor of a multistage free turbine or the only turbine rotor of a single stage free turbine). Generally, it will be understood that one or more injectors 140 of a turbine system 100 according to the present teachings may be structurally configured to supply liquid water within a certain water supply region 104, regardless of where the actual injectors 140 are located within the system. This water supply region 104—i.e., between the last stage first turbine rotor 122d of a gas turbine disposed upstream from a free turbine and the last stage free turbine rotor 132d of the free turbine—is shown in FIG. 1.

The water supply region 104 may include the N3-inlet zone described in more detail below. That is, the injector 140 may be structurally configured to supply liquid water within an inlet zone 206 (shown for example in FIG. 2, where this inlet zone 206 may contain the N3-inlet zone) of the free turbine. More generally, the inlet zone 206 may be disposed between the last stage first turbine rotor 122d and a first stage free turbine rotor 132a of the free turbine in the turbine system 100.

Also, or instead, the injector 140 may be structurally configured to supply liquid water between a first stage free turbine rotor 132a and the last stage free turbine rotor 132d—i.e., within the free turbine itself, such as between stages of a multistage free turbine. In this manner, the injector 140 may be a nozzle of the free turbine itself, where the nozzle is structurally configured to spray liquid water approximate to at least one free turbine rotor. Such a nozzle may be situated within an existing free turbine, e.g., where the nozzle is retrofitted to supply liquid water (for example, where the existing nozzle was originally structurally configured to supply another substance, such as fuel, steam, air, and the like). Such a nozzle may instead be otherwise applied to an existing free turbine, or a free turbine may be constructed to include one or more such nozzles configured to supply liquid water within the free turbine.

The injector 140 may be wholly or partially formed of a material having a moderate to high corrosion resistance (e.g., a non-corrosive metal or the like) such as stainless steel or the like. By way of example, an injector 140 may be constructed of grade, 440C stainless steel. In an implementation, an injector 140 may be made of 440C stainless steel that is suitable for high pressure and high temperature conditions found in a turbine system 100. In other implementations, the injector and/or nozzle as described in the present teachings may be constructed wholly or partially of a material such as CP-Ti (commercially pure titanium), titanium aluminum, nickel alloys and/or nickel-based superalloys (may include chromium, aluminum, titanium, molybdenum, niobium, tantalum, cobalt, tungsten) for high corrosion resistance injectors, and/or any stainless steel grades. Some implementations may use ceramic coatings to further protect the injector/nozzle.

The liquid water that is supplied by one or more injectors 140 of the turbine system 100 may be filtered and substantially purified. For example, the liquid water may be demineralized, and/or may undergo water treatment according to comprehensive cycle chemistry guidelines for fossil plants, EPRI limits, or steam purity and water quality for modern industrial steam turbines/boilers. For example, treatments or limits may include one or more of the following: alkalinity not to exceed 10% of specific conductance; other water chemistry limits; following common steam generator manufacturer's guidelines; phosphate and conventional feedwater treatment; treatment of excessive CO2, sodium, alkalinity, acid anion, CI, SO4, carryover of silica, and the like; oxygenated/caustic treatment; and similar. In other implementations, water treatment or application may generally follow industry standard guidelines for makeup water treatment or similar methods. Also or instead, the liquid water may be supplied by an injector 140 at a pressure between 2.75 Bar and 220 Bar (about 40 psi to 3100 psi), inclusive. Also or instead, if the pressure at the water exit point (e.g., water injection discharge) is equal to the atmospheric pressure then the liquid water may be supplied by an injector 140 at a pressure between about 1 Bar and 220 Bar (about 14.5 psi to 3100 psi), inclusive. Also or instead, the liquid water may be supplied by an injector 140 at a pressure below 2.75 Bar (below about 40 psi). Other pressures are also or instead possible—e.g., supercritical water can exceed 220 Bar or 3200 psi. Additionally or alternatively, the liquid water may be supplied by an injector 140 at a temperature between about 200-degrees Fahrenheit and 705-degrees Fahrenheit, inclusive. Such temperatures may provide more of a “dry” steam. Additionally or alternatively, the liquid water may be supplied by an injector 140 at a temperature between about 40-degrees Fahrenheit and 212-degrees Fahrenheit (inclusive), which may provide a more “wet” steam. Other temperatures are also or instead possible—e.g., from just above the freezing point of water (or even below that point if pressures are provided to maintain flowable water) to over 705-degrees Fahrenheit if using supercritical water.

Thus, as described herein, the injector 140 may be structurally configured to supply liquid water between the last stage first turbine rotor 122d and the last stage free turbine rotor 132d. When liquid water is supplied by the injector 140 in this location (i.e., the water supply region 104), heat transferred from combustion gases within the turbine system 100 (e.g., combustion gases exiting the first turbine 120) to the liquid water may cause vaporization of the water. And, in turn, a pressure increase from the vaporization of the water may increase power output of the second turbine 130 (e.g., the free turbine of the turbine system 100). Also or instead, the supply of liquid water by the injector 140 may increase a mass flow rate across at least one of the free turbine rotors to increase power output thereof. Thus, the present teachings may benefit from the effects of the addition of liquid water within a turbine system 100 in the specified location(s) such as a pressure increase from vaporization of the liquid water to steam and a mass flow rate increase across a turbine rotor caused by the addition of the water into the turbine system 100.

The benefits provided by the present teachings may not require the addition of any excess fuel relative to a same or similar system that lacks the supply of liquid water in the water supply region 104 as described herein. That is, no excess fuel may need to be provided to the first turbine 120 for the increased power output of the second turbine 130 provided by the present teachings. Further, in addition to or instead of other benefits of the present teachings as described herein, the present teachings may reduce a need for a heat recovery steam generator (HRSG). For example, the turbine system 100 may completely lack a HRSG; alternatively, a smaller (e.g., in size or scale) HRSG may be included relative to an HRSG that would otherwise be included in a similar system that lacks the supply of liquid water in the water supply region 104 as described herein. Another advantage that may be accomplished through the use of the present teachings is that the supply of liquid water by the injector 140 may reduce exhaust gas temperature for the turbine system 100. For example, the temperature of exhaust gases exiting the first turbine 120 may be reduced and/or the temperature of exhaust gases exiting the second turbine 130 may be reduced. Also or instead, the supply of liquid water by the injector 140 may reduce carbon emissions (e.g., CO or CO₂) and/or nitrogen emissions (NO)ₓ) for the turbine system 100.

The turbine system 100 may include one or more additional elements commonly found in such systems. For example, the turbine system 100 may further include a gear reduction unit 150 or the like disposed downstream from the second turbine 130. Also or instead, the turbine system 100 may further include an electric generator 180 or the like, e.g., coupled to one or more of the compressor 110 and the second turbine 130 (e.g., directly or indirectly).

The turbine system 100, or generally any of the systems described herein, may further include the use of combustion gases for aiding in the supply of liquid water before or along the second turbine 130 as described herein. That is, the arrows 203 shown in FIG. 2 generally representing the fluid path of combustion gases through the turbine system 100 may also or instead represent piping, ducting, or the like, that routes combustion gases, exhaust gases, and/or the like for, e.g., preheating a supply of water that will be injected by one or more injectors 140 in the turbine system 100. Thus, in some implementations, it will be understood that the present teachings may employ a steam turbine system and/or another turbine system (e.g., turbines for receiving gases) which is not part of the first turbine 120. This technique may utilize gas turbine exhaust flow mass that provide relatively high temperature flue gases to enter and power a steam turbine system and/or the second turbine 130 or the like, e.g., where the location of water injection is disposed at an inlet of a first stage turbine rotor of the steam turbine system and/or the second turbine 130, or at other advantageous locations as described herein. In one example, a gas turbine system includes a 14-stage compressor coupled (e.g., shaft coupled) to a 4-stage turbine and features a ducting system for channeling the exhaust mass flow of the gas turbine into a steam turbine system and/or another turbine. The location of water injection may be disposed at an inlet of a first stage turbine rotor of the steam turbine system and more particularly water injection occurs between a first stage turbine rotor of the steam turbine system and a last stage turbine rotor of the steam turbine system. In such implementations, the gas turbine exhaust mass may hold relatively high temperatures (e.g., 1200-degrees Fahrenheit). When this exhaust mass enters the inlet and/or another location of a steam turbine system and/or a second turbine 130, it transfers heat to liquid water that is injected into the flow of exhaust mass. By way of example, liquid water is injected at any turbine blade of a steam turbine system and/or a second turbine 130. Due to latent heat of evaporation liquid, water becomes steam, and the increased pressure and steam mass increase power output of the steam turbine system and/or second turbine 130. Additional electrical power may be generated in this implementation.

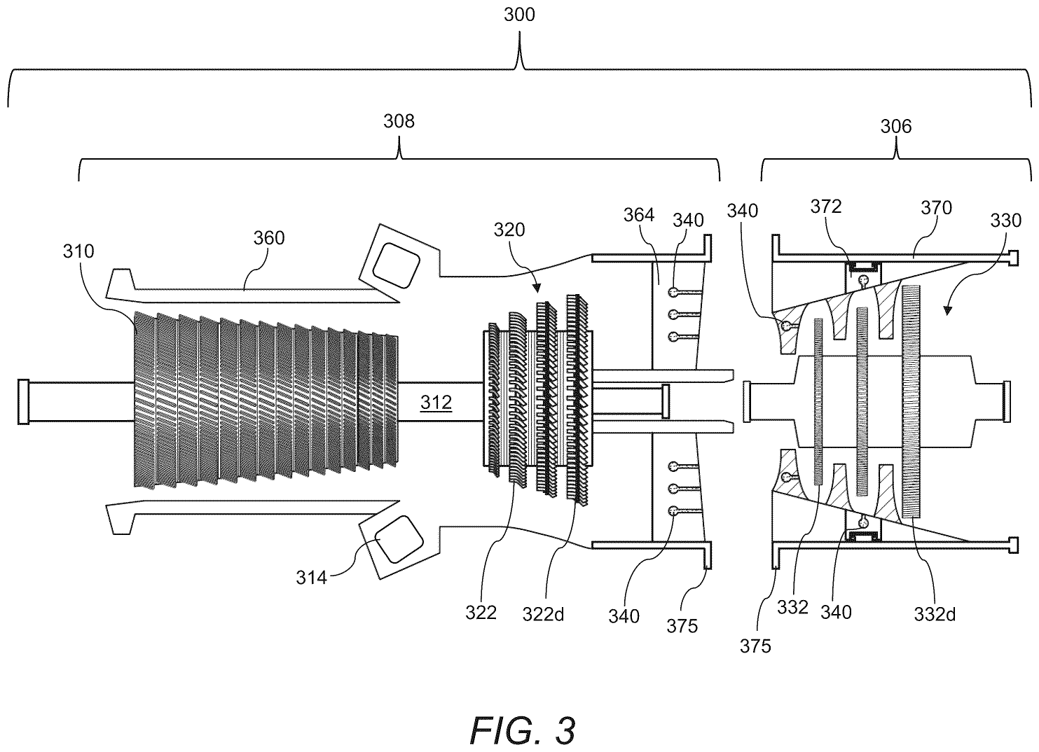

FIG. 3 shows a gas turbine and an apparatus for supplementing a gas turbine, in accordance with a representative embodiment. Thus, collectively, FIG. 3 shows a gas turbine system 300 including a gas turbine 308 (which may be referred to in this example embodiment as an existing gas turbine 308) and a turbine apparatus 306 for supplementing the gas turbine 308 and/or coupling to the gas turbine 308 for forming the gas turbine system 300. In certain aspects, the turbine apparatus 306 may be structurally configured to retrofit the gas turbine 308 thus forming a gas turbine system 300 according to an aspect of the present teachings. In this manner, and as stated above, the gas turbine 308 may be an existing gas turbine 308 in certain aspects, although it will be understood that the gas turbine 308 may instead be a new turbine structurally configured to be couplable (e.g., optionally couplable) with a turbine apparatus 306 to form a gas turbine system 300 according to an aspect of the present teachings.

Each of the existing gas turbine 308 and the turbine apparatus 306 may include a housing, which shall be referred to in the example of FIG. 3 as a first housing 360 for the gas turbine 308 and a second housing 370 for the turbine apparatus 306. It will be understood that the first housing 360 and the second housing 370 may be similar, and thus, features described with respect to the first housing 360 will be understood as being applicable to the second housing 370, and vice-versa. And similarly, although certain components may be shown in the figure as included on or within only one of these housings, it will be understood that these components may also or instead be disposed on or within the other housing—two such examples are the turbine shrouds 372 (i.e., only shown in the figure within the second housing 370, but certainly also could be found, and would likely be found, within the first housing 360) and radial struts 364 (i.e., only shown in the figure within the first housing 360, but certainly also could and would likely be found within the second housing 370). Further, it will be understood that the gas turbine system 300 is representative, and thus certain components are omitted to simplify the system for an easier understanding of the present teachings. Thus, it will be understood that the gas turbine system 300 can (and likely would) include other components, more robust components, and the like. By way of example, the housings and shafts are shown in a relatively simplistic and thus representative manner.

Therefore, one or more of the first housing 360 and the second housing 370 may include features commonly found in gas turbine systems and the like. For example, one or more of the first housing 360 and the second housing 370 may include one or more turbine shrouds 372—e.g., one or more turbine shrouds 372 may be found within one or more of the first housing 360 and the second housing 370, where they are coupled to the housing and/or the turbines. It will generally be understood that a turbine shroud 372 may include a feature disposed on or adjacent to the tips of turbine rotors (which, as described herein, may also referred to as ‘blades’ in the art) to impart a certain characteristic on the turbine rotor, such as a specific pressure, flow, fluid condition, temperature, balance, reinforcement, support, and the like. For example, a turbine shroud 372 may surround (cover) tips of a turbine rotor. It will be understood that such turbine shrouds 372 may be include on or approximate to any one of the turbine rotors of the gas turbine system 300.

One or more of the first housing 360 and the second housing 370 may also or instead include one or more radial struts 364. It will generally be understood that a radial strut 364 may include a feature of a housing for providing support and/or structure thereto. This may include radial struts 364 that extend radially between annular outer and inner casings that form the housing. The radial struts 364 may be sized and shaped to provide a substantially rigid frame for carrying loads (e.g., bearing loads from the inner hub/casing radially outwardly to the outer casing of the housing). In some aspects, one or more radial struts 364 are substantially hollow.

The second housing 370 may be structurally configured for coupling to the existing gas turbine 308, e.g., the second housing 370 may be structurally configured for coupling to the first housing 360. Similarly, the first housing 360 may be structurally configured for coupling to the turbine apparatus 306, e.g., the first housing 360 may be structurally configured for coupling to the second housing 370. By way of example, one or more of the first housing 360 and the second housing 370 may include a flange 375 or the like that can be coupled (e.g., bolted or the like) to an adjacent housing or component thereof. Other mating features and/or fastening means are also or instead possible, including without limitation, one or more of a feature included on an inner casing of a housing, a feature included on an outer casing of a housing, mating shafts and/or bores, projections and/or voids, clamps, bolts, rivets, and the like.

The existing gas turbine 308 may generally include a compressor 310, a first turbine 320, a shaft 312 coupling the compressor 310 and the first turbine 320, a combustion system 314, and/or any other components commonly found in a gas turbine system or the like— where one or more of these components is disposed at least partially within the first housing 360. The first turbine 320 may be the same or similar to others as described herein. For example, the first turbine 320 may include one or more first turbine rotors 322—i.e., one first turbine rotor in a single stage turbine (not shown) or a plurality of first turbine rotors 322 in a multistage turbine such as that shown in the figure by way of example. In this manner, the first turbine 320 may include a last stage first turbine rotor 322d, which will be understood as being the only rotor in a single stage turbine (not shown) or the last of a plurality of turbines in a multistage turbine relative to a direction of flow of combustion gases or other fluids through the existing gas turbine 308 or the gas turbine system 300 overall.

The turbine apparatus 306 may include a second turbine 330 configured to be disposed downstream from the first turbine 320 when the turbine apparatus 306 and the existing gas turbine 308 are coupled. The second turbine 330 may thus be at least partially disposed within the second housing 370. The second turbine 330 may be a free turbine having one or more free turbine rotors 332—i.e., one free turbine rotor in a single stage free turbine (not shown) or a plurality of free turbine rotors 332 in a multistage free turbine such as that shown in the figure by way of example. In this manner, the second turbine 330 (i.e., the free turbine in this example) may include a last stage free turbine rotor 332d, which will be understood as being the only rotor in a single stage free turbine (not shown) or the last of a plurality of turbines in a multistage free turbine relative to a direction of flow of combustion gases or other fluids through the turbine apparatus 306 or the gas turbine system 300 overall. Stated otherwise, the second turbine 330 may include a last stage free turbine rotor 332d disposed furthest downstream from the first turbine 320 relative to a fluid path of combustion gases through the existing gas turbine 308 when the second housing 370 is coupled to the first housing 360 (or, more generally, when the turbine apparatus 306 is coupled to the existing gas turbine 308).

The gas turbine system 300—e.g., one or more of the turbine apparatus 306 and the existing gas turbine 308—may include one or more injectors 340. For example, the turbine apparatus 306 may include one or more injectors 340 coupled to the second housing 370 or another portion of the turbine apparatus 306. Also or instead, the gas turbine 308 may include one or more injectors 340 coupled to the first housing 360 or another portion of the existing gas turbine 308. Regardless of how or where it is coupled, and regardless of what component(s) it is coupled to, an injector 340 may be configured such that, when the turbine apparatus 306 is coupled to the existing gas turbine 308 (e.g., when the first housing 360 is coupled to the second housing 370), the injector 340 (and/or a supply of liquid water therefrom) may be disposed downstream from the last stage first turbine rotor 322d. In this manner, the injector 340 may be structurally configured to supply liquid water between the last stage first turbine rotor 322d and the last stage free turbine rotor 332d. And, when so supplied by the injector 340, heat transferred from combustion gases from the existing gas turbine 308 (or otherwise from the gas turbine system 300) to the liquid water may cause vaporization of the water. In this manner, and as described herein, a pressure increase from the vaporization may increase power output of the second turbine 330, and/or the supply of liquid water by the injector 340 may increase a mass flow rate across at least one of the free turbine rotors 332 to increase power output of the second turbine 330.

FIG. 3 shows a plurality of possible locations for one or more injectors 340 according to the present teachings, and it will be understood that these locations are provided by way of example and not limitation. In general, an injector 340 may be located anywhere in the gas turbine system 300 such that liquid water is supplied within a specific water supply region as described herein, which may include a region between the last stage first turbine rotor 322d of the first turbine 320 and the last stage free turbine rotor 332d of the second turbine 330.

By way of example, an injector 340 may be structurally configured to supply liquid water between a turbine shroud 372 of the free turbine and at least one of the free turbine rotors 332. In this manner, in certain aspects, an injector 340 may be located at least partially within and/or adjacent to one or more turbine shrouds 372 within the turbine apparatus 306. And it will be understood that more or less turbine shrouds 372 (with or without injectors 340) may be included in a system according to the present teachings. Also or instead, an injector 340 may be structurally configured to supply liquid water approximate to a radial strut 364 of the gas turbine system 300—e.g., a radial strut 364 of the existing gas turbine 308 and/or a radial strut 364 of the turbine apparatus 306. In certain aspects, an injector 340 may be disposed within the radial strut 364. And it will be understood that more or less radial struts 364 (with or without injectors 340) may be included in a system according to the present teachings. Other locations for injectors 340 are also or instead possible.

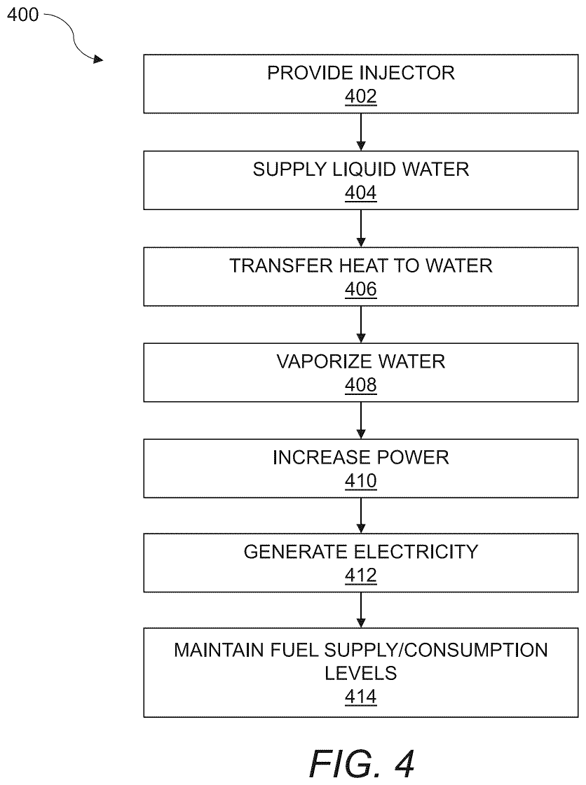

FIG. 4 is a flow chart of a method demonstrating injection techniques for gas turbines, in accordance with a representative embodiment. The method 400 may be performed using any one or more of the systems, devices, and apparatuses described herein, such as any described with reference to FIGS. 1-3 above. In general, the method 400 may be used to increase power output in a gas turbine system, e.g., by increasing a power output of a free turbine included in such a system through the supplying of liquid water between the last stage free turbine rotor of the free turbine and a last stage turbine rotor of a gas turbine disposed upstream from the free turbine in a gas turbine system.

As shown in step 402, the method 400 may include providing an injector, e.g., downstream from a first turbine relative to a fluid path of combustion gases through the first turbine. In particular, this may include providing an injector within a gas turbine system in any suitable location to supply liquid water between a last stage first turbine rotor of the first turbine and a last stage free turbine rotor of a free turbine disposed downstream from the first turbine. The injector may thus be provided in one or more of the locations as specified herein. For example, in some implementations, the injector is provided after the first turbine but before at least one free turbine rotor of a free turbine disposed downstream from the first turbine. Also or instead, an injector may be provided between a shroud of a free turbine and at least one of the free turbine rotors thereof. Also or instead, an injector may be provided approximate to a radial strut of a housing of the gas turbine system, e.g., within the radial strut itself.

Providing the injector may include retrofitting an existing gas turbine system with a nozzle in communication with a supply of water. For example, retrofitting such an existing gas turbine system may include converting one or more existing nozzles in the gas turbine system to supply water within the gas turbine system. Also or instead, retrofitting such an existing gas turbine system may include coupling one or more new nozzles to the gas turbine system to supply water within the gas turbine system. This may include adding new nozzles/injectors to a gas turbine system, e.g., by drilling into a housing or another portion thereof. Also or instead, retrofitting an existing gas turbine system may include placing a free turbine adjacent to an outlet of the first turbine, e.g., where one or more nozzles are disposed on the free turbine and are configured to supply liquid water as disclosed herein. That is, in certain aspects, a housing may include one or more injectors/nozzles as well as at least a portion of a free turbine, and the housing may be structurally configured to couple to a corresponding housing that includes at least a portion of the first turbine. In this manner, the housings may be coupled together to form a system as described herein that includes a first turbine, one or more injectors to supply liquid water downstream from a last stage first turbine rotor of the first turbine, and a free turbine downstream from the first turbine.

As shown in step 404, the method 400 may include supplying liquid water at a location between the first turbine and a last stage free turbine rotor of a free turbine that is disposed downstream from the first turbine relative to the fluid path of combustion gases through the first turbine. More specifically, this may include supplying liquid water at a location between a last stage first turbine rotor of the first turbine and a last stage free turbine rotor of the free turbine. By way of example and not limitation, this may include supplying liquid water at the N3-inlet zone as described below.

As shown in step 406, the method 400 may include transferring heat from combustion gases to the liquid water to vaporize the liquid water. It will be understood that this may happen passively within a gas turbine system, i.e., without a need for any other adjustments other than supplying liquid water in the specified location(s). That is, heat that is present within the gas turbine system (e.g., directly downstream from the first turbine) may vaporize the liquid water, where this heat would be present regardless of whether the liquid water was present within the system.

As shown in step 408, the method 400 may include vaporizing the water, e.g., using the heat transfer described above in step 406.

As shown in step 410, the method 400 may include increasing a power output of the free turbine and thus the turbine system. The increase in power output of the free turbine may be caused at least in part by a pressure increase from vaporization of the liquid water. The increase in power output of the free turbine may also or instead be caused at least in part by an increase in mass flow rate from the supply of liquid water.

As shown in step 412, the method 400 may include generating electricity from the power output of the free turbine and/or the first turbine.

As shown in step 414, the method 400 may include maintaining a fuel supply that can be used for the first turbine absent the supply of liquid water. That is, the method 400 may not require any excess fuel beyond what would be needed to operate a gas turbine system without such a supply of liquid water in the specified location(s).

Also or instead, and as described herein, the location of water injection may be disposed downstream of a high-pressure turbine, and more particularly water injection may occur between a last-stage turbine discharge and a last-stage blade of the free turbine.

Several examples of the location of water injection in a turbine system according to the present teachings will now be described, where it will be understood that these are provided as examples only, and should not be considered exclusive or limiting to the present teachings. In one example, the location of water injection is disposed downstream of a high-pressure turbine, and more particularly water injection occurs between a last-stage turbine wheel and the last-stage free turbine wheel. In another example, the location of water injection is disposed downstream of a high-pressure turbine, and more particularly water injection occurs between a last-stage turbine wheel and a last-stage nozzle of the free turbine. In another example, the location of water injection is disposed downstream of a high-pressure turbine, and more particularly water injection occurs between a first-stage nozzle of the free turbine and a last-stage blade of the free turbine. In another example, the location of water injection is disposed downstream of a high-pressure turbine, and more particularly water injection occurs through a nozzle of the free turbine, where at least one injector is positioned within a nozzle for spraying water into a free turbine blade. In another example, the location of water injection is disposed downstream of a high-pressure turbine, and more particularly water injection occurs between a free turbine shroud and a free turbine blade. In another example, the location of water injection is disposed downstream of a high-pressure turbine, and more particularly water injection occurs within a radial strut of the exhaust frame, where at least one injector is positioned within a radial strut for spraying water into the free turbine inlet.

Therefore, as described herein, the present teachings may include water injection within certain advantageous locations within a gas turbine system featuring a free turbine, such as where the water injection occurs at the location closest to the free turbine inlet, such that the location of water injection is disposed downstream of a high-pressure turbine, and more particularly between a last-stage turbine and the free turbine inlet. An example is provided: a gas turbine engine includes a 14-stage compressor coupled (e.g., shaft coupled) to a 4-stage turbine and featuring a free turbine including a system for injecting water at an inlet of the free turbine. The water injection in this example may occur between the fourth stage turbine and the free turbine inlet. One advantage of this example is that gas turbine manufacturers or developers may be able to more effectively and efficiently adapt to water injecting at the free turbine inlet. This can provide a cost and time effective method for manufacturers or developers in order to implement the present teachings into existing gas turbines for the purpose of augmenting power output. Thus, there may be no need to invest in major redesigns, alterations, modifications, etc. of the gas turbine overall design (e.g., compressors, combustion system, turbines, etc.). In general, only the gas turbine's aft exhaust may be modified to adapt the water injecting directed at the free turbine inlet. Therefore, water injection may occur between a last-stage turbine and the free turbine inlet, where this implantation may be highly cost effective; this implementation is described in more detail below with respect to the N3 inlet zone.

N3-Inlet Zone Embodiment and Study

Having described various injection techniques for gas turbines, the disclosure now turns to techniques where liquid water is supplied within a specific zone—the N3-inlet zone. The N1, N2, and N3 are common terms in aviation gas turbines. They describe shaft/spool rotational speed at different locations within an engine and are often expressed as percentage of maximum normal operating RPM of the spool. However, it will be understood that the N3-inlet zone, N3i, N3, N3 turbines (or similarly phased) as used herein may refer to the location of a free turbine and/or may refer to a free turbine inlet. For example, a free turbine inlet may be N3i, where N3 represents the spool downstream of a first turbine and the “i” of N3 represents the inlet of the free turbine. It will be understood that the embodiments described above may utilize any features described below, and vice-versa. Thus, the discussion of the supply of liquid water in the N3-inlet zone will be understood to be included by way of example and not limitation, e.g., where liquid water may also or instead be supplied anywhere between a last stage turbine rotor of a turbine disposed upstream from a free turbine and a last stage free turbine rotor of the free turbine.

As described herein, the present teachings may include techniques that can increase the performance of gas turbines, where the present teachings may be implemented into existing conventional natural gas simple and combined-cycle plants. Although other locations are also or instead possible such as any of those as described above, the present teachings may involve the delivery of high-quality liquid water (to create steam) into the entrance of the inlet zone of the free turbines (e.g., power turbine) in a turbine system. Introducing high-pressure water-to-steam in such a beneficial location (e.g., the N3-inlet zone) may involve a particularly sensitive area of expansion—meaning the expansion process may gain considerable pressure energy that augments power to the free turbines, which can increase efficiency and lead to noteworthy gas turbine performance. That is, the N3-inlet zone may be advantageous for water injection because, in this zone, expansion from the heating of the injected water may be used to create relatively high-pressure steam, which in turn may be used to provide power to the free turbine. Whereas, if the water injection is disposed in another location, such advantageous pressurized steam may not be utilized effectively or efficiently. By way of example, simulations for a gas turbine of 33.7 MW for mid to high power ratings modified with the present teachings yielded results of about a 40% to 124% increase in mechanical drive power output by free turbines (N3) available for power generation. A phenomenon that occurs when water is rapidly converted into steam is that it exhibits an exponential water-to-steam expansion ratio of about 1600:1. Thus, this means that an injection system according to the present teachings that delivers high-quality steam into the inlet of a free turbine (a region called the N3-inlet zone) may increase the mechanical drive power output of N3 turbines and may increase the average torque of the N3 turbines, thus increasing available turbine work. In this manner, the present teachings may be related to improving the overall efficiency of a natural gas power plant and reducing its emissions considerably.

The present teachings may thus be related to the compressors and turbines of industrial gas turbines, which may represent some of the most critical components of natural gas power plants. In this manner, the present teachings may provide advantages to these turbines related to compressor efficiency and compressor work. That is, most gas turbines suffer from incredible energy loss stemming from the required compressor work (which may be about 66%). The compressors of industrial gas turbines may consume the majority portion of energy given by the turbine work, which greatly degrades turbine work. However, the present teachings can restore and boost turbine work on a continuous operating cycle—e.g., by delivering advanced water-to-steam injection into a modified gas turbine. The water-to-steam dynamics delivery system may function with respect to the enthalpy of saturated steam. A water injection method according to the present teachings may deliver high-quality filtered water into the N3i-inlet zone immediately after the turbine discharge stage also known as N2f (hp turbine outlet) by means of delivering relatively high-pressure atomized water injection at a relatively low micron diameter size. The resultant effect of the steam heat of vaporization process may be that the steam vaporization pressure is applied as augmented pressure across the free turbine zones. Meaning there may be an increase in pressure and/or mass flow rate, and a resulting increase in mechanical drive power output of the free turbines (also known as increased turbine work). Introducing high-pressure water-to-steam in the location called the N3-inlet zone may result from this zone being a particularly sensitive area of expansion. Specifically, the expansion process may gain considerable pressure energy that augments power to the free turbines, which is noteworthy because the effects to compressor demands may be negligible because there is no axial connection between compressor/hp turbines and the free turbines. Thus, the increased mass flow rate may not increase power to the high-pressure turbines but only to the free turbines. And, as such, extra fuel may not be required to compensate for stoichiometric combustion, which may represent a significant improvement for gas turbines featuring free turbines. Additionally, the present teachings may significantly reduce the scale of heat recovery steam generators (HRSGs). The present teachings may be used to effectively lower energy costs on a national scale and/or to provide significant and practical cost benefits.

An aspect of the present teachings may include a water injector (which may be referred to herein as “SDI N3i Injection” and similar); an eductor inlet for increased mass flow rate; and an injected oxidizer. Each of these components/features is further described below.

SDI N3i Injection: this will be understood to include a water-to-steam delivery interface (or “SDI” where it will be understood that liquid water is supplied, but heat transfer from combustion gases and the like will vaporize the liquid water to steam, and thus SDI may be used herein) in the proximity location of a free turbine inlet (N3i), where N3 represents the spool downstream of the high-pressure, intermediate-pressure, and low-pressure turbines. At times herein this technology may be referred to as a modified gas turbine, and/or a SDI N3i modified gas turbine and similar

The technology of SDI N3i Injection for a modified gas turbine may involve the delivery of high-quality water-to-steam into the entrance of the inlet zone of the free turbines. In some implementations, this is (relatively) very high-pressure water that is injected into the N3i inlet zone. This delivery action may increase torque and overall power output of a modified gas turbine. The SDI N3i high-quality steam and water delivery methods may be closely related. Therefore, a SDI N3i water injection method will now be described.

The water-to-steam dynamics delivery system may function with respect to stagnation enthalpy. The SDI N3i water injection method may deliver relatively high-quality filtered water (or similar) into the N3-inlet zone immediately after the turbine discharge stage also known as N2f (turbine outlet), e.g., by means of delivering atomized water injection at relatively low micron diameter size. The resultant effect of the steam heat of vaporization process may include steam vaporization pressure that is applied as augmented pressure across the free turbine zones. This may create an increase in pressure and/or mass flow rate, and thus an increase in mechanical drive power output of the free turbines, also known as increased turbine work. Introducing high-pressure water-to-steam in this location (the N3-inlet zone) may thus utilize a particularly sensitive area of expansion. Meaning the expansion process may gain considerable pressure energy that augments power to the free turbines. This may be noteworthy because the effects to compressor demands may be negligible. This injected fluid action into the N3-inlet zone may extract required heat to reach about 300° F. without extracting excessive power from the compressor within a modified gas turbine. Additionally, the N3i (inlet zone) and free turbine section(s) may experience a reduction in exhaust gas temperature, where a reduction in nitrogen oxides (N0 x) are probable.

The SDI N3i modified gas turbine may be coupled to a generator for producing electrical power. The exhaust gases of the modified gas turbine engine may be routed into a half-scale heat recovery steam generator (e.g., in a combined-cycle arrangement) in order to thermally power a high-temperature steam cycle for additional electrical power generation. This may add to the thermodynamic cycle, and this may be the basic model of a combined-cycle modified gas turbine plant arrangement according to the present teachings. Regarding ultra-low energy and compression systems for a simple cycle: marginally high-pressure discharge models may be optimized for simple-cycle plant arrangement which provides better performance. Other implementations for simple-cycle plant variations may exclude the half-scale heat recovery steam generator (HRSG).

Implementations may include the use of an injected oxidizer, where it will be understood that these techniques may be the same or similar to those described in U.S. Pat. No. 9,638,111, which is hereby incorporated by reference in its entirety. The combustion effects for introducing oxygen-enriched mixtures (e.g., mixtures of about 21% to about 45% oxygen) may thus be applied. Introducing oxygen-enriched mixtures into the combustor of a modified gas turbine according to the present teachings may thus be considered. This may provide stabilizing effects to the thermal flow near the high-pressure turbine sections, where the greatest benefits may be seen in increased mass flow rate methods for gas turbines. The present teachings may thus include methods for medium increases in mass flow rate at the eductor inlet and considerable increases in mass flow rate to the free turbine (N3i) location. Oxygen-enriched mixtures may aid in combustion stabilities and thermal flow specifically for increased mass flow rate in gas turbines. However, it will be understood that the present teachings may not require oxygen-enriched mixtures in order for gas turbines according to the present teachings to be highly effective. Therefore, it will be understood that oxygen-enriched methods for combustion may not be required, but may be included as an added feature of the present teachings.

Physics-Based Modeling for SDI N3i Gas Turbine Dynamics

Fundamentals of Steam Enthalpy: before describing the SDI N3i Gas Turbine Dynamics, a recap on steam enthalpy—meaning specific enthalpy of saturated liquid and saturated vapor—will be briefly described. This greatly aids in understanding what the math means for SDI N3i (injection) Gas Turbine Dynamics.

Specific Enthalpy of Saturated Water. Saturated water at standard atmospheric pressure, with regard to specific enthalpy is h_{f}=419 kJ/kg. Meaning when the atmospheric pressure is about 14.7 psi, water boils approaching 100° C. The fundamentals for calculating the energy of steam are relatively basic and easy to understand.

Specific Enthalpy of Saturated Steam. Specific enthalpy of saturated steam h g in regard to standard atmospheric pressure of 14.7 psi may be: h_{g}=2,676 kJ/kg. Specific enthalpy of evaporation may also be calculated as:

hₑ=h_{g}−h_{f}

where hₑ=specific evaporation enthalpy (kJ/kg).

This represents the evaporation (specific enthalpy) for water at standard atmospheric pressure:

hₑ=(2,676 kJ/kg)−(419 kJ/kg)=2,257 (kJ/kg)

The fundamentals for calculating the energy of steam are well understood. Enthalpy of saturated steam is also considered the total heat of saturated steam. Enthalpy of saturated steam thus describes the steam power return for a SDI N3i modified gas turbine according to the present teachings. This means that relevant estimates may be yielded for understanding augmented power return at the N3 free turbine. The fundamental steam power return for SDI N3i Injection is described below.

An example study of a Water-to-Steam Delivery Interface (SDI-N3i) according to the present teachings will now be described.

Some benefits and outcomes may include one or more of the following, which will be understood to be examples and not limiting:
Physical phenomenon of injected water-to-steam increases free-turbine disk pressure resulting in torque augmentation (increased turbine work).
Increased N3 (free turbine) torque yields greater mechanical power output at constant RPM.
SDI N3i injector position: at turbine discharge zone preceding free-turbine inlet (1.055-inch aft-gap clearance). Injector class is titanium-base ceramic swirl stator.
Latent heat of vaporization facilitated by thermal kinetic energy at turbine discharge zone located at N3i.
Injected water volume (x) will vaporize into steam by a volumetric expansion ratio of 1600(x).
Reduction in oxides of nitrogen (NO)ₓ) formation rate within exhaust gas emissions. In some implementations reducing NO by about 70% to 95%.
In other implementations reducing NO by about 90% to 99%.

Various computational methods for this example study of a Water-to-Steam Delivery Interface (SDI-N3i) according to the present teachings will now be described.

Rankine Cycle: Steam Turbine Power

Steady-Flow Form of an Isentropic Turbine

First Law of Thermodynamics

q=0=h₂−h₁+wₜ

wₜ=h₁−h₂
q=rate of heat transfer (BTU/sec or kJ/sec)
h₂=turbine exit enthalpy (BTU/lbm or kJ/kg)
h₁=turbine entrance enthalpy (BTU/lbm or kJ/kg)
wₜ=turbine work per unit mass (N-m/kg or Ft-lb/lbm)

Total Heat of Saturated Steam @ 1.0 Atm, 100° C.

h_{g}=h_{f}+h_{fg}
h_{g}=total enthalpy of saturated steam=2,676 kJ/kg or 1,151 BTU/lbm
h_{f}=liquid enthalpy=419 kJ/kg or 180 BTU/lbm
h_{fg}=enthalpy of evaporation=2,257 kJ/kg or 971 BTU/lbm

It will be understood that the water-to-steam delivery interface for this example will be at the position of N3i. Computational methods and continued results thus follow.

Heat Source

T_{f}=[(Pₒ/FT_{eff})]/[(1,056)]
T_{f}=turbine discharge heat (BTU/sec)
Pₒ=free-turbine mechanical power output (Watts)
FT_{eff}=free-turbine efficiency (decimal form)

SDI N3i Injection Method % Mechanical Power Increase

+4% SDI=>m_{4%}=[(0.04Pₒ)/(FT_{eff})(1,056)(h_{g})]

+5% SDI=>m_{5%}=[(0.05Pₒ)/(FT_{eff})(1,056)(h_{g})]

+6.88% SDI=>m_{6.88%}=[(0.0688Pₒ)/(FT_{eff})(1,056)(h_{g})]

+10% SDI=>m_{10%}=[(0.1Pₒ)/(FT_{eff})(1,056)(h_{g})]

+124% SDI=>m_{124%}=[(0.124Pₒ)I(FT_{eff})(1,056)(h_{g})]
m=water injection (lbm/sec)
Pₒ=free-turbine mechanical power output (Watts)
FT_{eff}=free-turbine efficiency (decimal form)
h_{g}=total enthalpy of saturated steam=1,151 BTU/lbm

Summary for Simulated Tests

Empirical evidence reveals that enthalpy of saturated steam correlates with increased N3 free-turbine mechanical power output. Primarily through the transfer of heat into water (liquid enthalpy) inducing latent heat (enthalpy of evaporation), culminating into total heat of saturated steam. Facilitated by SDI-N3i (water injection according to an aspect of the present teachings) placement at the turbine discharge zone preceding free-turbine(s) inlet, where superheating of water into steam occurs. The total thermal kinetic energy escaping the turbines will experience a drop in temperature as water injection occurs. Superseded by a rise in effective N3 free-turbine disk pressure greater than the pressure induced from thermal kinetic energy. A phenomenon that occurs when water is rapidly converted into steam, is that it exhibits an exponential water-to-steam expansion ratio of 1600:1. The subsequent increase in N3 free-turbine disk pressure induces greater torque output while RPM remains relatively constant. Ultimately increasing N3 free-turbine mechanical power output and/or brake horsepower.

Example Findings

Investigations on SDI N3i modified gas turbines according to the present teachings were aimed at studying the influence of water-to-steam injection at the N3-inlet zone. A preferred injector class may be a titanium-base ceramic swirl stator. In studied modeling cases (including a gas turbine of 33.7 MW), gas turbines using SDI N3i techniques according to the present teachings resulted in increased overall turbine work. For example, increases in water lbs/sec delivery through injectors such as titanium-base ceramic swirl stators, was found to have increased the N3 turbines (free turbines) power and torque. This may provide a direct increase in power output of the N3 free turbines, which increases overall turbine work (e.g., over 100% percent). This may be a direct result from water being injected into the N3-inlet zone. The required latent heat of vaporization may be supplied to the water within the high-temperature region of the N3-inlet zone, where the delivered water becomes the gaseous phase (i.e., steam). A physical phenomenon occurs when water is rapidly converted into steam, exhibiting an exponential water-to-steam expansion ratio of 1600:1. The kinetic energy from this introduced steam may be transferred to the N3 turbines (e.g., reaction blades) immediate upon impact, which continues the steam-through-turbine expansion stage. Thus, there may be an increase in pressure and/or mass flow rate, and thus an increase in mechanical drive power output of the free turbines, also known as increased turbine work. Introducing high-pressure water-to-steam in the location called the N3-inlet zone may thus involve a particularly sensitive area of expansion. Meaning the expansion process may gain considerable pressure energy augmenting power to the free turbines. This may be noteworthy because the effects to compressor demands may be negligible. Because there is no axial connection between compressor/high-pressure turbines and free turbines, the increased mass flow rate may not increase power to the high-pressure turbines but only to the free turbines. This can further result in extra fuel not being required to compensate for stoichiometric combustion (or less extra fuel required), which can be massively advantageous. Additionally, the present teachings may significantly reduce the scale of Heat Recovery Steam Generators (HRSG).

In example modeling tests, higher water pressure per second rates yielded higher N3 turbine power output (about 50% to 100%); however, the example study focused on highly reasonable life-cycle predictions and fatigue life optimization for the blades and components. Thus, careful consideration was taken for keeping parts and components within realistic fatigue estimates, especially considering real-world applications.

The Present Teachings and HRSGs

Regarding heat recovery steam generators (HRSG), the utility segment (for power generation) is holding the largest market share owing to the wide deployment of combined-cycle plants by the utility sector. HRSGs, though costly, are thus integral to the utility market. However, the present teachings suggests that a reduced scale HRSG may be possible for next generation combined-cycle power plants. A HRSG is typically critical equipment of a combined-cycle power plant that connects the gas turbine system to the steam cycle (see, e.g., Rezaie, A., et al., “Thermal design and optimization of a heat recovery steam generator in a combined-cycle power plant by applying a genetic algorithm,” Energy, 168, 346-57 (2019), https://doi.org/10.1016/j.energy.2018.11.047, which is incorporated by reference herein). The HRSG is essentially an enormous heat exchanger, which recovers much of the wasted exhaust gases directly from the gas turbine. Once the waste heat has been transferred into the tubes, that heat is transferred into the form of water-to-steam in order to power the steam turbine cycle. Some HRSGs are equipped with additional supplemental firing located at the duct entrance, which increases 1\4W output at the cost of reducing plant's efficiency. Concerning producing lower thermodynamic efficiency for combined-cycle gas turbines (CCGT) of this type, supplementary firing is accompanied by a decrease in its efficiency (see, e.g., Teplov, B. D., et al., “The extension of the operational range of combined-cycle power plant with a triple-pressure heat recovery steam generator,” Journal of Physics: Conference Series, Conf. Ser. 891 012208 (2019), https://iopsciencelop.org/article/10.1088/1742-6596/891/1/012208/meta, which is incorporated by reference herein). HRSGs are typically complex structures that include selective catalyst reduction (SCR) for NOₓ emissions control, along with many other complex systems and sub-systems, which are contributing factors to their considerable capital and operating costs.

A present method of heat recovery for HRSG includes three subsystems: economizers, boilers, and superheaters. All three subsystems are usually systematically intensive. Within the traditional HRSG system, the economizers, boilers, and superheaters generate superheated steam for the steam turbines. The present method of heat recovery within a HRSG system may be considerably inefficient, especially with regard to exhaust travel. The gas turbine's exhaust gases usually must travel far distances through the duct entrance past the distribution grid, where more heat energy is added via the duct burners. This increases MW output and adversely effects overall efficiency. The exhaust gases then flow past the H.P. superheater and H.P. evaporator. The exhaust gases then flow past multiple networks of injection grids and networks of selective catalyst reduction. The exhaust gases then flow past the economizer, and additional evaporators, superheaters, and pre-heaters. After traveling up to 140 ft. or more, the exhaust gases may then escape the HRSG's network via the stack. Meaning the HRSG is useful for recovering wasted heat; however, typically at a great cost in complexity and a considerable capital and operating cost.

However, the present teachings may eliminate the need for excessively large scale and complex HRSGs. The reason for this may be that the steam or water is introduced at the earliest stage (N3i) near the free turbines, rather than water being superheated into steam within the complex tubing networks of the HRSG system. The direct result of a SDI N3i Injection method of the present teachings may be that steam vaporization pressure will be applied as augmented pressure across the free turbine zone (e.g., aft turbines). Meaning there may be an increase in pressure, mass flow rate, and an increase in mechanical drive power output of the free turbines, also known as increased turbine work. Basically, while the HRSG system allows water to become superheated into steam for the purpose of transferring that steam great distances into the steam turbines, the SDI N3i Injection method of the present teachings for gas turbines may fundamentally do the same thing as the HRSG system, except that the water-to-steam process is near instantaneous and applied to the gas turbine N3i location resulting in immediate power increase to the turbines. Also, this means that there may be no need for the steam to be transferred great distances. Because of this considerable power increase, smaller steam turbine units may be more practical. By contrast, the HRSG's water-to-steam process is delayed by extensive exhaust travel and system complexity (e.g., excessive network of tubes)— the heated steam must typically travel great distances to reach the steam turbines. Also, the HRSG system typically uses complex methods for reducing NOₓ generally called selective catalyst reduction (SCR). However, a SDI N3i Injection technique of the present teachings for a gas turbine may reduce NOₓ levels. This may be predominantly due to the SDI N3i Injecting system lowering gas temperatures during the expansion stage within the free turbine zone. Thus, a SDI N3i Injection method of the present teachings for gas turbines may provide for a less complex combined-cycle power plant at a lower capital cost. Additionally, next generation HRSGs could be significantly less complex at a lower capital and operating cost due to the benefits of the present teachings.

First Variant and Second Variant, Explained

The present teachings may include at least two embodiments, which may be referred to herein as a first variant and a second variant, where each is described below.

One or more of the first variant and the second variant of an ultra-low energy and compression system may be related to technology for implementation into combined-cycle and simple-cycle natural gas power plants. More particularly, this technology may be implemented into future and existing natural gas combined-cycle and simple-cycle plants. These techniques may improve the overall efficiency of natural gas power plants and reduce their emissions considerably (especially by cost-comparison). The first variant may represent SDI N3i technology described herein within the ultra-low energy and compression systems. The second variant may include modified thermal heat recovery systems, equipment layouts, and augmented sub-systems directly within ultra-low energy and compression systems. The second variant may provide considerable benefits for the steam cycle and emissions.

Example Research Findings for the First Variant

Simulations for an example SDI N3i modified gas turbine (33.7 MW) yielded overall results of about 40% to about 124% increase in mechanical drive power output by free-turbines (N3) available for power generation. Meaning the example SDI N3i injection system delivering high-quality steam into the critical region (N3-inlet zone) increased the mechanical drive power output of N3 turbines and increased the average torque of the N3 turbines; this increased total turbine work.

Thus, increased turbine work is achievable in gas turbines of a combined-cycle arrangement: meaning gas turbines that operate on a lower efficiency and overall low to mid pressure ratios. This demonstrates probable evidence for better gas turbine performance in a combined-cycle arrangement.

And thus, increased turbine work is achievable in gas turbines of a simple-cycle arrangement: meaning gas turbines that operate on a higher efficiency and overall higher pressure ratios. This demonstrates probable evidence for better gas turbine performance in a simple-cycle arrangement.

The present teachings may thus utilize a more efficient water-to-steam delivery system. This can lead to a reduced scale lower-complexity heat recovery steam generator (HRSG) that may be included in a system. This may be noteworthy because a considerable reduction in capital and operating costs for the plant is probable.

Turbine gross power output losses may be restored because of the present teachings. This can significantly improve the turbine-to-compression work ratio. Meaning the excessive work typically required by the compressor may be reduced when compared to the total turbine work gains.

The present teachings may include a less complex final build process compared to the prior art systems. Meaning implementation into a natural gas simple and/or combined-cycle plant may be within a reasonable or practical cost.

Further, nitrogen oxides (N0 x) levels may be reduced as a direct result from a SDI N3i Injection within gas turbines. This may be because of an SDI N3i injecting system that lowers gas temperatures during the expansion stage within the free turbine zone.

The present teachings may be used for heavy-duty industrial gas turbines. That is, the present teachings may be structurally configured to deliver high-quality steam into the entrance of the inlet zone of free turbines, where introducing high-pressure water-to-steam in this location (the N3-inlet zone) deals with a particularly sensitive area of expansion. Thus, the present teachings may involve augmenting N3 turbines within a modified gas turbine. This may present a significant improvement in gas turbine performance.

Heat Rate

At least for the past four decades, the research industry has approached the problem of high inlet air temperatures for gas turbines without a meaningful solution. This may be because the industry has mainly focused on lowering the ambient air temperatures at the inlet region of the gas turbine. While the present teachings may be able to lower the ambient air temperatures, the present teachings—and in particular SDI N3i Injection—may provide other benefits. For example, the present teachings may significantly lower required fuel flow to total power output; predominately located at the N3 turbine section. This may assist with a type of ratio referred to as “turbine-to-compression work ratio gains” within the gas turbine. A known problem is that the compressors of gas turbine engines typically consume the majority of the turbine's total power output. More specifically relating to heavy-duty industrial gas turbine engines, the compressor work of a gas turbine may require almost 66% of the total turbine power—this is also known as turbine's gross power output. To put this into perspective, consider the General Electric 9HA.02 Harriet—when configured into a combined-cycle (2×1) performance arrangement, the GE 9HA.02 maintains a net heat rate of (<5,878 kJ/kWh), and a net plant output of 1,398 MW (see GE Power & Water, “9HA gas turbine world's largest, most efficient gas turbine,” available at https://www.ge.com/content/dam/gepower-pgdp/global/en_US/documents/product/gas%20turbines/Fact%20Sheet/unused%20assets/9ha-fact-sheet.pdf (2014)). This means that the GE 9HA.02 turbines extracting all the heat and pressure energy will lose two-thirds of its turbine's gross power output through the mechanical transmission for compression. This is certainly an enormous mechanical transmission loss because of the conventional compressors. The present teachings may significantly restore these gross power output losses. Thus, a significant portion of advances may come from forms of SDI N3i Injection technology, which may introduce high-pressure steam or water into the location called the N3-inlet zone within a sensitive area of expansion. Meaning the expansion process may gain considerable pressure energy augmenting power to the free turbines. As a direct result, more turbine power output may be available to benefit both cycles of power generation. This may lead to an improvement in power plant heat rate and/or a reduction in heat recovery systems.

Combined-Cycle Power Plants

The present teachings may be utilized in combined-cycle power plants. That is, not only may the present teachings be utilized in high-performance, high-pressure-ratio gas turbines (e.g., aeroderivative gas turbines), but the technology may be scalable on a wide range of applications, including industrial power generation applications. Thus, the present teachings may be highly adaptable and diverse, meaning many systematic changes could be made with no or little adverse performance effects. In some implementations, enhanced performance with multiple thermodynamic cycles may be possible, where these plants generally have advantages in high overall efficiency and are commonly known as combined-cycle power plants. Furthermore, an aspect of the present teachings may reduce the scale of modern heat recovery steam generators (HRSG), where HRSGs are generally exceedingly expensive heat recovery buildings. Moreover, the present teachings may provide a greater turbine-to-compression work ratio, and increased turbine work may be achievable in gas turbines of a combined-cycle arrangement, meaning gas turbines that operate on a lower efficiency and overall low- to mid-pressure ratios. These types of turbines may be well suited for combined-cycle arrangement and combined-cycle plants. Turbines with low- to mid-pressure ratios may have superior specific power, and combined-cycle plants may depend on maintaining an improved specific power. The present teachings may provide positive results with this class of gas turbine, e.g., due to the higher firing temperatures. Moreover, the present teachings may benefit and reduce the scale of the heat recovery steam generator (HRSG) within a combined-cycle power plant.

By improving the turbine sections for natural gas industrial gas turbines there may be notable efficiency improvements, which may include: greater turbine-to-compression work ratio, and increased turbine work within combined-cycle arrangement. This may be significant because combined-cycle power plants provide enormous power generation on a national scale. And because the present teachings may enable a reduced scale heat recovery steam generator (HRSG)—e.g., a modified gas turbine according to the present teachings may produce increased power to the free turbines, meaning less steam may be needed to be produced from the HRSG and delivered to the steam turbines. This may be significant because HRSGs are exceedingly expensive heat recovery large-scale buildings: somewhere in the order of $170 million for a large-scale plant (3000 MW). For smaller-scale plants (1126 MW), the overnight costs may be closer to $55 million. Using the present teachings, there may be a significant reduction in scale and substantial reduction to complexity of the HRSGs, which can operate in connection with SDI N3i modified gas turbines disclosed herein. Plants that operate in a combined-cycle arrangement may have a combined-cycle efficiency that is achieved with considerably greater firing temperatures and relatively lower pressure ratios, which may be primarily for maintaining an improved specific power. Therefore, these plants may require a specific balancing of the described factors in order to maintain an effective secondary thermodynamic cycle, which is the steam cycle. As an advantage, the present teachings may not have any adverse effects to these balancing requirements concerning pressure ratio and firing temperatures. Additionally, a SDI N3i Injection technique may reduce the formation of oxides of nitrogen (N0 x). In summary, the present teachings may provide an advantageous heat recovery efficiency solution for combined-cycle power plants, which may reduce the capital and/or operating costs of such plants.

Simple-Cycle Power Plants

The present teachings may improve the performance of gas turbines that operate on a higher efficiency and overall higher-pressure ratios. That is, gas turbines found in simple-cycle power plant arrangements may also utilize aspects of the present teachings. High performance gas turbines with high efficiencies may benefit from the present teachings because the technology may have a profound effect on the total turbine work. And this power cycle may be even more profound when in a power plant configuration, which may lead a modified gas turbine to operate at marginally higher-pressure ratios, where these higher-pressure ratios may be ideally suited for simple-cycle power plants. Simple-cycle power plants typically depend on high performance gas turbines with high efficiencies, where commercial simple-cycle gas turbines reach efficiencies up to about 40% at large power levels. These plants typically cannot depend upon a heat recovery steam generator for a secondary thermodynamic cycle, and this can be the principal reason for the need of higher-pressure ratios. When the pressure ratio to a gas turbine increases, the specific power decreases. This essentially means that simple-cycle plant operators achieve better performance with higher pressure ratios, however at a cost to specific power. Regardless, and advantageously, the present teachings may not have any adverse effects to the requirements for an optimized simple-cycle power plant operation, and may thus provide a solution for simple-cycle power plants, especially in terms of significant power output gains.

Some examples of problems in existing systems will be described below, where more context is provided regarding how aspects of the present teachings may solve these existing problems.

The Present Teachings Vs. Water/Steam Injection into the Combustor of a Gas Turbine

Although water/steam injection has been used in gas turbines for power augmentation before, there are limitations when considering injecting water or steam into the inlet, compressor, and/or combustor of a gas turbine. For example, if the water/steam to fuel ratio is exceeded there will be a loss of combustion stability within the gas turbine combustor. Major disadvantages for injecting water/steam into a gas turbine combustor may include: combustion/flame instabilities, combustion efficiency loss, incomplete combustion, and a drastic increase in carbon monoxide (CO). Moreover, as the water-to-fuel ratio increases there is a thermal efficiency reduction that effectively increases specific fuel consumption (SFC). This is due to the fact that fuel efficiency is highly dependent on gas turbine thermal efficiency. Thus, for at least these reasons there have been limitations set by manufactures for water/steam injection rates into the gas turbine combustor. Industrial gas turbine designers typically set the steam injection rate not to exceed 5% steam mass into combustor. Regarding water injection rates into the combustor, designers typically set the water-to-fuel mass ratios between 1.0 and 2.0. Water/steam injection above these limits can lead to serious problems in the combustor, where some examples include: flame instabilities, drop in firing temperature, combustion efficiency loss, incomplete combustion, and a drastic increase in CO.

However, the present teachings may effectively solve the aforementioned problems caused by water/steam injection into a gas turbine combustor. This may be because the location of water injection in an aspect of the present teachings is disposed downstream of a high-pressure turbine, and more particularly between a last-stage turbine rotor (of a turbine coupled to compressor) and the inlet of a free turbine (and/or the last-stage free turbine rotor). Water injection at this location may not interfere with the natural combustion chemistry. This may be because the combustor firing temperature is not reduced, as water is not injected into the combustor. Instead, water injection may occur between the last-stage turbine rotor of the first turbine and the last-stage free turbine. In contrast, in many existing water/steam-to-combustor injection techniques, water/steam is injected into a gas turbine combustor, which reduces the flame temperature by a heat exchange process within the flame zone (e.g., heat sink effect). This can inhibit combustion performance, reduces combustion operating stability, and, if injection exceeds limits, the flame may blow out. The present teachings thus generally do not employ water injection at the engine-inlet, compressor, and/or combustor locations. Therefore, the natural combustion chemistry may remain, and peak combustion performance is possible. That is, studies of the present teachings have shown no adverse effects on combustion, at least because the water delivery is situated relatively far from the combustion process. Furthermore, studies of the present teachings have shown significant advantages over existing steam injected gas turbines (STIGs) in terms of combustor efficiency and fuel efficiency, e.g., based on more stable firing temperatures because aspects of the present teachings only inject water in the advantageous zone(s) described herein, rather than at or near the combustor.

Water/Steam to Combustor Limits

Limiting factors for steam-to-combustor, water-to-combustor, or water-to-compressor injection techniques may include that the injected water/steam negatively effects combustion performance and combustion chemistry as described above. Therefore, water/steam injection rates into the combustion system typically have strict limits to prevent combustion performance losses. Typically, the steam injection rate is not to exceed 5% steam mass into combustor; and regarding water injection rates into the combustor, the water-to-fuel mass ratio is usually 2.0 or less.

However, an advantage of the present teachings may include that water injection rates into the water supply region as described herein may be far greater than those allowed for injection rates of water/steam into the combustor and/or the inlet/compressor of a gas turbine. Relatively high water injection rates into the water supply region may be advantageous because high power return from the free turbine can be possible. In one example, an excess of 100% overall power increase was shown. Within the present teachings, water may not be delivered into any combustion zone, but rather, the location of water injection is disposed downstream of a high-pressure turbine, and more particularly water injection occurs between a last-stage turbine wheel and a last-stage free turbine wheel. Therefore, water injection into any combustion zone never occurs in some aspects of the present teachings. As a result, combustion performance and combustion chemistry can remain unaltered.

In gas turbines, natural combustion chemistry has already taken place in the approximate location of one-quarter to one-half of the distance traveled into the combustion chamber (e.g., fuel nozzle—primary zone). The completed combustion area may also be known as the primary combustion zone. This means combustion is completed approximately midway into the combustion chamber. Secondary combustion is completed near the midway area within the combustion chamber as well. The present teachings may solve the problem of water/steam mass interfering with combustion by injecting liquid water between the last-stage of the first turbine and the last-stage of the second turbine as described herein. Thus, the present teachings may bypass the combustion system and first turbine altogether; meaning that water injection may affect areas downstream of the first turbine discharge, but it may not disturb the natural combustion chemistry (e.g., combustion process) of any combustion zones. In this manner, the present teachings can permit for effective water injection rates up to 70 times greater (and up to 144 times greater in some aspects) compared to steam-to-combustor, water-to-combustor, or water-to-compressor injection techniques. The present teachings may thus allow for high water mass delivery/injection rates into a gas turbine without adverse combustion effects, which may not be possible with existing water/steam injection techniques.

Greater Water Mass Injection

Compared to existing steam-to-combustor or water-to-combustor injection techniques, the present teachings may be able to apply significantly greater water mass injection into a gas turbine without adversely affecting combustion. In one implementation, it was found that the present teachings delivered 42 times more water mass into the free turbine inlet as compared to a gas turbine using 5% steam injection into combustor. In another implementation, two 405 MW gas turbines were compared, where the present teachings delivered 30 times more water mass into the free turbine inlet as compared to a comparable gas turbine using 5% steam mass injection into combustor. In another implementation, two 570 MW gas turbines were compared, where the present teachings delivered 28 times more water mass into the free turbine inlet as compared to a comparable gas turbine using 5% steam mass injection into combustor. In another implementation, two 33 MW gas turbines were compared, where the present teachings delivered 24 times more water mass into the free turbine inlet as compared to a comparable gas turbine using 5% steam mass injection into combustor.

Water to Fuel Mass Ratio

The present teachings may advantageously provide an increase in water to fuel mass ratio over existing systems. And some aspects may be able to provide a relatively large increase over existing systems, where it will be understood that some of the large increases discussed below may actually negatively impact turbine parts. However, it will be understood that these large increases are provided by way of example, and that less of an increase is thus possible and may be desirous for turbine parts to operate correctly.

In an implementation, two 405 MW gas turbines were compared, where the present teachings delivered 70 times more water mass into the free turbine inlet as compared to a comparable gas turbine using a water-to-fuel mass ratio of 1.0 into the combustor. In another implementation, two 570 MW gas turbines were compared, where the present teachings delivered 60 times more water mass into the free turbine inlet as compared to a comparable gas turbine using a water-to-fuel mass ratio of 1.0 into combustor. In another implementation, two 405 MW gas turbines were compared, where the present teachings delivered 12 times more water mass into the free turbine inlet as compared to a comparable gas turbine using a water-to-fuel mass ratio of 1.0 into combustor. In another implementation, two 405 MW gas turbines were compared, where the present teachings delivered 35 times more water mass into the free turbine inlet as compared to a comparable gas turbine using a water-to-fuel mass ratio of 2.0 into combustor. In another implementation, two 570 MW gas turbines were compared, where the present teachings delivered 14 times more water mass into the free turbine inlet as compared to a comparable gas turbine using a water-to-fuel mass ratio of 2.0 into combustor.

It was found that the present teachings did not negatively affect combustion performance in any studied case, even with water mass delivery rates over 70 times more compared to steam-to-combustor, water-to-combustor, or water-to-compressor (e.g., inlet fogging) injection techniques. The present teachings similarly did not affect combustion chemistry process or combustion efficiency. Further, the present teachings did not cause flame instabilities, firing temperature drop, incomplete combustion, or an increase in carbon monoxide (CO). Thus, the present teachings allowed for unaltered combustion performance in investigated implementations.

Furthermore, the present teachings showed advantages over steam-to-combustor, water-to-combustor, or water-to-compressor injection techniques (including water/steam-to-inlet/compressor) such as: improvements on combustion efficiency, flame stability, firing temperature, and full range combustor operating stability. Emission advantages may include: reduction in carbon (CO2), reduction in nitrogen oxides, and no increase in carbon monoxide (CO).

Supercritical Water

In some implementations, the present teachings may utilize supercritical water, where it will be understood that, with supercritical water, the distinct liquid and gas phases do not exist. For example, in some implementations, the present teachings may inject water with a pressure above 220 Bar and a temperature above 705-degrees Fahrenheit.

In one example, the water to be injected is heated to supercritical water conditions. For example, the water pressure may be about 18,644 PSIG within the water pipes of the water delivery system, and the preheated water temperature within the pipes may be about 710-degrees Fahrenheit. And, in certain aspects, part or all of the water pipes may enter into the gas turbine exhaust (and/or any hot section), where heat exchange can occur to preheat the water therein. Then, the water may be injected within the water supply region as described herein

Water Delivery Based on Gas Turbine Exhaust BTU/S

In some implementations, the liquid water injection rate may be determined by available British Thermal Unit (BTU) within the exhaust of a gas turbine. For example, the gas turbine exhaust may contain 506,880 BTU per second; and the water injection rate may be set to 440 pounds per second; this may provide 1152 BTU/lb for saturated vapor. In other implementations, the gas turbine exhaust containing 506,880 BTU per second may provide sufficient heat to reach 1200 BTU/lb for saturated vapor, and in other implementations a far greater enthalpy (e.g., steam hg) may be reached. Many of these values simply depend on the pressure, temperature, and/or exhaust mass flow of the gas turbine. Therefore, a water injection rate may be set according to the pressure, temperature, and/or exhaust mass flow of any given gas turbine system. It will be understood that these are examples only, and that in some aspects, the present teachings can utilize more or less dry steam, or more or less wet steam, etc.

Employing Liquid Water or Steam

In some implementations, a water delivery system according to the present teachings may inject steam. In an example: a 405 MW gas turbine uses 24 injectors positioned annularly, and a water injection system surrounds the exhaust casing allowing injectors to have an entrance into the free turbine inlet and/or within nozzles of the free turbine. Liquid water may be used in this injection system, however due to latent heat of evaporation, the liquid water may become steam while still in the injection system (e.g., piping outside of the exhaust casing). This may be due to a designed insulation system and/or from heat transfer (thermal radiation) from the exhaust casing. In other words, the injected mass in an aspect of the present teachings may be in the form of wet steam or dry steam.

Thus, in an aspect, liquid water may become steam at any point within the injection system in preparation to inject the mass. For example, in an aspect, steam formation may occur anywhere in the orifice/nozzles, valves, regulators, injection controllers, orifice/nozzles inputs, input of a nozzle guide vane/shroud of a free turbine, piping, and/or an annular ring, and/or in any portion of a water delivery system that supplies water to the injection system.

Furthermore, in an aspect, a partial section of one or more water piping systems may enter into the gas turbine sections such as: exhaust casing, exhaust assembly, exhaust frame, exhaust diffuser, exhaust plenum, flow passages, radial struts, turbine shell, insulation packs, or bearings. In simple terms, in an aspect, a partial section of one or more water piping systems may traverse through any hot section of a gas turbine (e.g., combustion/exhaust sections), which can serve the purpose of preheating the water, or preheating the water into steam (e.g., within the piping of the water delivery system) via heat exchange. In this implementation, liquid water may become steam before being supplied within a gas turbine system as set forth herein—e.g., at any point within the water injection system to be injected according to the present teachings.

Additionally, in an aspect, the liquid water within the water delivery system may be at relatively high pressures (e.g., about 220 Bar), and in other implementations, water pressure may be significantly higher. Also or instead, the water temperature in preparation for injection may be anywhere between a temperature above its freezing point and 705-degrees Fahrenheit (i.e., its critical point). Therefore, in some implementations, the liquid water may be injected at or near the critical temperature of 705-degrees Fahrenheit.

Multiple Sets of Free Turbines

In some implementations, the present teachings may include more than one free turbine, i.e., multiple sets of free turbines downstream of a first turbine within a gas turbine system. In such aspects, the location of water injection may be disposed downstream of the first turbine in the system, and more particularly, water injection may occur between the last stage turbine rotor of the first turbine and any of the free turbine rotors of one or more of the sets of free turbines.

Condensing Steam from Gas Turbine Exhaust

In some implementations, the present teachings may employ one or more methods for condensing steam, for example within a gas turbine exhaust, back into water. In general, any steam-to-water converter, steam-to-water heat exchanger, hot water generator, heat exchanger, and/or any method that condenses steam back into liquid water may be used for the purpose of adding to a water source or supplying a water source according to the present teachings (e.g., water supply/source for a water injection system).

Relatively high water injection rates may be used, for example 3,000 pounds of water per second will become 3,000 pounds of steam per second. Thus, it may become economical to recycle and recirculate the water from the gas turbine exhaust (e.g., to be a water supply for the water injection system, wholly or partially). In one example, a steam turbine surface condenser is used with the present teachings. In an aspect, gas turbine exhaust containing steam enters the steam turbine surface condenser and the heat exchange process will condense the steam (within exhaust gases) and form condensate water, where this liquid water can be transferred to a recycling and recirculating water system to be a water source for the water injection system to be injected according to the present teachings.

In another example, a shell and tube heat exchanger may be used with the present teachings. In an aspect, gas turbine exhaust containing steam enters the vapor opening of a shell and tube heat exchanger. In this example, the heat transfer will condense the steam, which produces water droplets. Thereafter, the condensate, which is water, flows to an outlet.

The water flow from any outlet of at least one steam-to-water heat exchanger (e.g., one or more devices that condense steam to water) may be employed in a recycling and recirculating water system to be, at least/in-part, a water source for an water injection system to be injected according to the present teachings. In some implementations, this water source may go through a water treatment process according to industrial turbine steam purity specifications/guidelines for water quality/water chemistry limits (e.g., steam purity of silica, sodium, cation conductivity, excessive phosphate carryover). In general, the present teachings may include techniques aiding in the prevention of weak acids or anything that may corrode/damage the turbine blades or systems of the present teachings.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings.

Unless the context clearly requires otherwise, throughout the description, the words “comprise,” “comprising,” “include,” “including,” and the like are to be construed in an inclusive sense as opposed to an exclusive or exhaustive sense; that is to say, in a sense of “including, but not limited to.” Additionally, the words “herein,” “hereunder,” “above,” “below,” and words of similar import refer to this application as a whole and not to any particular portions of this application.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Thus, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

Numerous variations, additions, omissions, and other modifications will be apparent to one of ordinary skill in the art. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A gas turbine system, the system comprising:
a first turbine having one or more first turbine rotors including a last stage first turbine rotor;
a second turbine, wherein the second turbine is a free turbine disposed downstream from the first turbine relative to a fluid path of combustion gases through the gas turbine system, the free turbine having one or more free turbine rotors including a last stage free turbine rotor disposed furthest downstream along the fluid path from the first turbine; and
an injector disposed downstream along the fluid path from the last stage first turbine rotor, the injector structurally configured to supply liquid water between the last stage first turbine rotor and the last stage free turbine rotor, including supplying liquid water approximate to a radial strut of a housing of the gas turbine system, wherein, when so supplied by the injector, heat transferred from the combustion gases to the liquid water causes vaporization of the water, and wherein a pressure increase from the vaporization increases power output of the second turbine.

2. The system of claim 1, wherein the supply of liquid water by the injector increases a mass flow rate across at least one of the one or more free turbine rotors to increase power output thereof.

3. The system of claim 1, wherein the injector is structurally configured to supply liquid water within an inlet zone of the free turbine, the inlet zone disposed between the last stage first turbine rotor and a first stage free turbine rotor of the one or more free turbine rotors.

4. The system of claim 1, wherein the injector is structurally configured to supply liquid water between a first stage free turbine rotor and the last stage free turbine rotor.

5. The system of claim 1, wherein the injector is structurally configured to supply liquid water between a shroud of the free turbine and at least one of the one or more free turbine rotors.

6. The system of claim 1, wherein the injector is disposed within the radial strut.

7. The system of claim 1, wherein the liquid water is supplied by the injector at a pressure between 2.75 Bar and 220 Bar, inclusive.

8. The system of claim 1, wherein the liquid water is supplied by the injector at a temperature between 200-degrees Fahrenheit (93.33-degrees Celsius) and 705-degrees Fahrenheit (373.89-degrees Celsius), inclusive.

9. The system of claim 1, wherein the first turbine is a multistage turbine such that the last stage first turbine rotor is one of a plurality of turbine rotors of the first turbine.

10. The system of claim 1, wherein the free turbine is a multistage turbine such that the last stage free turbine rotor is one of a plurality of turbine rotors of the free turbine.

11. The system of claim 1, wherein a shaft of the free turbine is uncoupled from a shaft of the first turbine.

12. The system of claim 1, wherein no excess fuel is provided to the first turbine for the increased power output of the second turbine.

13. The system of claim 1, wherein the supply of liquid water by the injector reduces one or more of: exhaust gas temperature, carbon emissions, and nitrogen emissions for the gas turbine system.

14. The system of claim 1, wherein water used for the supply of water is preheated prior to being supplied by the injector by exhaust gases from the first turbine.

15. An apparatus for supplementing a gas turbine, the apparatus comprising:
a housing structurally configured for coupling to an existing gas turbine, the existing gas turbine including a first turbine having one or more first turbine rotors including a last stage first turbine rotor;
a second turbine at least partially disposed within the housing, wherein the second turbine is a free turbine having one or more free turbine rotors including a last stage free turbine rotor disposed furthest downstream from the first turbine relative to a fluid path of combustion gases through the existing gas turbine when the housing is coupled to the existing gas turbine; and
an injector coupled to the housing such that, when the housing is coupled to the existing gas turbine, the injector is disposed downstream from the last stage first turbine rotor, the injector structurally configured to supply liquid water between the last stage first turbine rotor and the last stage free turbine rotor, including supplying liquid water between a shroud of the free turbine and at least one of the one or more free turbine rotors, wherein, when so supplied by the injector, heat transferred from the combustion gases from the existing gas turbine to the liquid water causes vaporization of the water, and wherein a pressure increase from the vaporization increases power output of the second turbine.

16. The apparatus of claim 15, wherein the injector is structurally configured to supply liquid water within an inlet zone of the free turbine, the inlet zone disposed between the last stage first turbine rotor and a first stage free turbine rotor of the one or more free turbine rotors.

17. The apparatus of claim 15, wherein no excess fuel is provided to the first turbine for the increased power output of the second turbine.

18. A method comprising:
providing an injector downstream from a first turbine relative to a fluid path of combustion gases through the first turbine, the injector provided by retrofitting an existing gas turbine system with a nozzle in communication with a supply of water;
supplying liquid water at a location between the first turbine and a last stage free turbine rotor of a free turbine that is disposed downstream from the first turbine relative to the fluid path;
transferring heat from the combustion gases to the liquid water to vaporize the liquid water; and
increasing a power output of the free turbine, wherein the increase in power output of the free turbine is caused at least in part by a pressure increase from vaporization of the liquid water.

19. The method of claim 18, wherein retrofitting the existing gas turbine system includes converting one or more existing nozzles in the gas turbine system to supply water within the gas turbine system.

20. The method of claim 18, wherein retrofitting the existing gas turbine system includes coupling one or more new nozzles to the gas turbine system to supply water within the gas turbine system.
